(19) United States
(12) Patent Application Publication
(10) Pub. No.: US 2026/0207305 A1
(43) Pub. Date: Jul. 23, 2026

(54) POLYFUNCTIONAL DENTAL DEVICES AND ASSOCIATED METHODS

(71) Applicant: Forstgarten International Holding GmbH, St. Gallen (CH)

(72) Inventors: Frank Hornung, Wolferschwenden (DE); Gerhard Polzar, Büdingen (DE); Johannes Landgraf, Karlsruhe (DE)

(21) Appl. No.: 18/865,548

(22) PCT Filed: May 17, 2022
(86) PCT No.: PCT/EP2022/063273

§ 371 Date: Nov. 13, 2024

(51) Int. Cl. A61C 7/08; A61C 7/00; B33Y 80/00

(52) U.S. Cl. CPC A61C 7/08; A61C 7/002; B33Y 80/00

(57) ABSTRACT

A series (100) of devices for incrementally changing the tooth position of a person (P), comprising at least two devices (10), is explained,
wherein the devices (10) each comprise at least one jaw device (11, 12),
wherein the at least one jaw device (11, 12) is designed such that receiving regions of the jaw device (11, 12) may be placed onto a dental arch of the upper jaw (OK, 5) or the lower jaw (UK, 4) of the person (P),
wherein the devices (10) are designed to provide, when worn according to a predetermined sequence of the devices (10), an incrementally progressive change in tooth position by mechanical interaction of the device and at least one tooth element.

The at least one jaw device (11, 12) of the first device (10.1, 10.2) may carry a first veneering element (N.I.1.2, N.IV.1.2) on its outer side as a partial area of the first device (10.1, 10.2). The at least one jaw device (11, 12) of the second device (10.n) may carry a second veneering element (N.I.1.n, N.IV.1.n) on its outer side as a sub-region of the second device (10). The first veneering element (N.I.1.2, N.IV.1.2) may be located at the same position according to a tooth scheme as the second veneering element (N.I.1.n, N.IV.1.n). A receiving regions of the first veneering element (N.I.1.2, N.IV.1.2) may be designed differently and/or have a different position than a receiving element of the second veneering element (N.I.1.n, N.IV.1.n),
this difference being suitable for effecting the incremental displacement of the tooth element, and
wherein a front-side wall thickness of the second veneering element (N.I.1.n, N.IV.1.n) differs from a front-side wall thickness of the first veneering element (N.I.1.2, N.IV.1.2).

The invention relates to a series of devices for incrementally changing the tooth position of a person, wherein the devices may each comprise at least two pairs of devices, as well as an associated design method, manufacturing method and further units.

### FIELD AND BACKGROUND

The present invention is in the field of dentistry. In dentistry, complexly designed devices and methods are used to:
1) Readjust the chewing/masticatory plane/chewing surface, and/or
2) To advantageously displace teeth in the dentition before, simultaneously or subsequently, and/or
3) To simultaneously improve the appearance and shape of the teeth aesthetically, whereby aesthetic improvements often also result in functional improvements.

Dentistry includes, for example:
The restoration of teeth,
The use of implants,
The esthetic correction and improvement of teeth,
The orthodontic displacement of teeth in their orientation and position in the upper jaw and lower jaw.

The correction of the position and orientation of the masticatory plane/chewing surface relative to the skull and the correction of disorders in the temporomandibular joint associated with unfavorable conditions in the dentition are also of particular importance.

### EMBODIMENTS

It is therefore the task of the invention to provide a series of devices for incrementally changing the position of a person's teeth, comprising at least two pairs of devices. The devices of the series should, for example, be simple and/or inexpensive to manufacture and/or enable a short treatment duration and/or have a high wearer acceptance and/or enable an overview of the status of the treatment at any time. In addition, a design method and a manufacturing method should be provided which may be used, for example, to design and/or manufacture the series of devices and which may alternatively also be used for other purposes. Furthermore, associated entities should be indicated, such as a computer system, a computer program, a computer program product and associated digital design data and associated digital manufacturing data.

This task is solved with regard to the series of devices by the series specified in claim 1. Further embodiments are indicated in the dependent claims. The problem relating to the methods and units is solved by the patent subject matter of the corresponding independent claims. Further embodiments are also indicated in the dependent claims.

The series of devices for incrementally changing the position of the teeth of a person, e.g. a patient, may comprise at least two devices, which in turn may each comprise at least one jaw device or at least two sub-devices, e.g. a pair of devices. The jaw devices may be designed in one piece or in several pieces.

The jaw device may include device elements. The device elements may each comprise at least one receiving region for tooth elements, i.e. for teeth, tooth replacement elements, etc. A dental veneer or a veneering element may be a device element, which is preferably arranged at an anterior tooth position or at a canine tooth position. At a molar position (molar, premolar), there may be device elements that have a height function or a ramp function, for example.

According to one embodiment, the devices may each comprise at least one jaw device. The at least one jaw device may be designed such that the receiving regions of the jaw device may be placed on a dental arch of the upper jaw, i.e. it may be an upper jaw device, or of the lower jaw, i.e. it may be an upper jaw device, of the person.

According to one embodiment, the devices may be designed such that, when they are worn according to a predetermined sequence of the devices, they cause an incrementally progressive change in the tooth position by mechanical interaction, i.e., for example, by the transmission of forces and/or moments, in particular torsional moments, of the device and at least one tooth element. Each device or at least more than half of the devices can, for example, displace at least one tooth by a distance in the range of, for example, 0.1 mm (millimeters) to 0.25 mm.

The dental element may be a tooth, e.g. a natural tooth, e.g. crowned or partially crowned, or an artificial tooth in which the root of the natural tooth has been replaced. The dental arch may be formed by dental elements arranged in an arch, so that it may also be referred to as a dental element structure.

In the attached or inserted state, the upper jaw device may extend from a first tooth element in a molar position via a second tooth element at a canine position or an anterior position to a third tooth element at a further molar position, which is on a different side of the dental arch than the molar position of the first tooth element. There may be corresponding receiving regions in the upper jaw device for each tooth element.

In the attached or inserted state, the lower jaw device may extend from a first tooth element in a molar position via a second tooth element at a canine position or an anterior position to a third tooth element at a further molar position, which is on a different side of the dental arch than the molar position of the first tooth element. There may be corresponding receiving regions in the lower jaw device for each tooth element.

According to one embodiment, the at least one jaw device of a first device may carry a first veneering element on its outer side as partial region of the first device, in particular as a partial region of the first jaw device.

According to one embodiment, the at least one jaw device of a second device may carry a second veneering element on its outer side as a partial region of the second device, in particular as part of the second jaw device.

According to one embodiment, the at least one optional jaw device of a third device may carry a third veneering element on its outer side as partial region of the third device. The inclusion of the optional third jaw device may serve in particular to delimit from “shaking movements” on the tooth elements.

All three veneering elements may be in the same position according to a tooth scheme. The veneering elements may also be referred to as tooth veneers.

In a first transverse cross-section, there may be a first outer contour and a first inner contour on the first veneering element, in particular a front-side outer contour and a front-side inner contour.

In a second transverse cross-section corresponding to the first transverse cross-section, there may be a second outer contour and a second inner contour on the second veneering element, in particular a front-side outer contour and a front-side inner contour.

Preferably, the following feature may also be optionally realized: In a third transverse cross-section corresponding to the first transverse cross-section, there may be a third outer contour and a third inner contour on or in the third veneering element, in particular a front-side outer contour and a front-side inner contour.

The relative position of the respective inner contour to the respective outer contour may change incrementally progressively from the first veneering element towards the second veneering element or via the second veneering element towards the third veneering element, in particular in order to enable or effect an offset of a tooth element in the relevant receiving region, in particular an offset in at least one or more of the following directions:
from front to back,
from the back to the front,
axial rotation,
laterally towards the neighboring tooth, i.e. to the left or to the right,
possibly also an offset from top to bottom or an offset from bottom to top.

The change in the relative position or offset may be strictly monotonic, in particular strictly monotonically increasing or decreasing in one direction. Alternatively, there may also be a simple monotonic increase. Thus, in a series of successive devices, there may also be devices in which the relative position remains the same, e.g. because an offset is caused on other teeth.

Thus, there may be no further devices between the first device, the second device and the third device according to the sequence. On the other hand, there may also be further devices between the first device and the second device and/or between the second device and the third device according to the sequence.

The numbering of the devices may differ from the numbering according to a treatment plan, but does not have to. This means that the first device may be the first device according to the treatment plan. Alternatively, the first device may also be a different device according to the treatment plan, e.g. the second device, the third device, etc. The other numbers according to the claim then follow.

The first device according to the claim may have a relative position A of inner contour and outer contour. The second device according to the claim may have a relative position B of inner contour and outer contour. The third device according to the claim may have a relative position C of inner contour and outer contour. Then, for example, the following sequence of layers may be realized: A, B, C or A, A, B, C, C or the like.

The transversal cross-section can, for example, have a target chewing plane as a reference or a plane that lies at a predetermined distance from the target chewing plane.

The relative position of the first inner contour to the first outer contour may differ from the relative position of the second inner contour to the second outer contour.

The displacement of the inner contour relative to the dental arch may be greater than the displacement of the outer contour relative to the dental arch. This means that the tooth may “wander” or move comparatively strongly and the tooth veneer, i.e. preferably its front side, may rest or only move comparatively slowly.

The inner contour may comprise pressure elements, i.e. functional elements for tooth displacement, in particular pressure elements that effect the displacement with at least one additional attachment on the tooth or tooth element or without attachments on the tooth or tooth element.

The change in the relative position of the inner contour to the outer contour may be reflected in a change in the wall thickness profile. For example, the wall thickness profile, in particular the front wall thickness profile, of the first veneering element may differ from the wall thickness profile of the second veneering element and the wall thickness profile, in particular the front wall thickness profile, of the third veneering element may differ both from the wall thickness profile of the second veneering element and from the wall thickness profile of the first veneering element, in particular due to a specific change in the relative position of the respective inner contour to the respective outer contour, e.g. in contrast to a deep-drawing process. in contrast to a thermoforming process using foils of uniform layer thickness, in which the inner contour and outer contour conform to each other and thus have an essentially constant position relative to each other.

The technical effect of changing the relative position of the inner contour and outer contour is that a degree of freedom is created that makes it possible to determine the position of the outer contour independently of the position of the inner contour. For example, the outer contour may be realized or aimed for early on in the series, while the inner contour “maps” the tooth elements or allows the tooth elements to be relocated.

A receiving region of the first veneering element may be designed differently and/or have a different position than a receiving region of the second veneering element. This difference may be suitable for effecting the incremental displacement of the tooth element. At the same time, a front-side wall thickness of the second veneering element may differ from a front-side wall thickness of the first veneering element, in particular when the tooth element is displaced from the front to the rear or from the rear to the front.

Thus, the wall thickness, in particular the front wall thickness, may generally decrease from the first veneer element towards the second veneer element and possibly also from the second veneer element towards the third veneer element when the tooth element is displaced from the rear to the front. The rear wall thickness may increase accordingly, for example, or remain unchanged.

Thus, the wall thickness, in particular the front wall thickness, may generally increase (along the entire course of the wall in the transverse cross-section) from the first veneer element towards the second veneer element and possibly also from the second veneer element towards the third veneer element when the tooth element is displaced from the front to the rear. The rear wall thickness can, for example, decrease accordingly or remain unchanged.

If a tooth element is displaced laterally, the front wall thickness may decrease in one section and increase in another section. However, the wall thickness to a neighboring tooth element may be reduced or increased overall or along the entire length of the wall, especially if the neighboring tooth element is not displaced at the same time. The same applies to rotating a tooth or lifting a tooth out of the upper jaw or lower jaw as well as to combined displacements, e.g. rotation and lifting out.

The first veneering element may be located at the same position according to a tooth scheme as the second veneering element. According to one embodiment, a receiving region formed in the first veneering element may be designed differently and/or have a different position than a receiving region formed in the second veneering element. Known tooth schemes are the quadrant scheme with four quadrants (e.g. upper right (seen from the patient), upper left, lower left and lower right) or a numbering of the teeth from left to right or from right to left in the upper jaw or lower jaw.

This difference in design and/or position may be suitable for causing the incremental displacement of the tooth element. A front-side wall thickness of the second veneering element may deviate from a front-side wall thickness of the first veneering element, for example due to this difference in design and/or position.

This series makes it possible, for example, to implement or approximate the position and/or shape of teeth or tooth elements after the final restoration in the devices at an early stage. If this position and/or shape may still change during treatment, reference may be made to provisional tooth/tooth element target states, for example. Other special dental features may also be taken into account.

The at least one first veneering element and the at least one second veneering element may substantially coincide/match in the position and/or the shape of their front-side outer contour.

The front-side outer contour may be adapted to the tooth element located at this tooth position in its target tooth state or in an intermediate target tooth state, e.g. of an intermediate target tooth arrangement, as is aimed for in a final restoration of the tooth element, e.g. with comparatively small associated tooth elements, such as teeth, tooth stumps, implants, etc. The tooth element may be regarded as a remaining biting element. Several remaining bite elements may form a remaining bite structure. Together with the devices, the remaining bite structure and the device may result in a temporary bite structure, which is then converted into a permanent bite structure in the final dental restoration that corresponds exactly to a target bite structure. Thus, the relocation of the tooth element(s) may be part of a treatment plan. Only a part of the tooth elements may need to be relocated. Another part may already be in a suitable position so that no further relocation is required.

“Adapted” may mean to match. Alternatively, “adapted” may mean that there is a match with the target state as far as the dental conditions permit.

The enlargement may take place in at least one spatial dimension or spatial direction, e.g. anisotropic, in at least two spatial dimensions (mutually orthogonal spatial directions, e.g. anisotropic or in all three spatial dimensions/directions (isotropic).

An isotropic enlargement can, for example, be a so-called blow-up in the case of a canine or premolar that is much too small. On the other hand, an anisotropic enlargement may be, for example, an increase in width.

The target tooth condition may also be defined more broadly as affecting not only individual teeth, but the entire dental arch. The dental arch in the device may already be an anticipation of the target state of the dental arch in the upper jaw and/or lower jaw, in particular of its outer contour and/or inner contour. The aim is often to enlarge the dental arch in the upper or lower jaw or both dental arches.

The front-side outer contour may represent an enlargement of the target tooth state in at least one dimension. According to another embodiment, the anterior tooth veneer of the first pair of devices and the anterior tooth veneer of the second pair of devices may represent the tooth located at this tooth position in a target tooth state or in an enlargement of the target tooth state. The magnification may be made by a value which may be, for example, in the range of 1 to 25 percent, preferably in the range of 5 to 15 percent, for example 10 percent. The magnification may be performed using a factor, e.g. a magnification factor in the range from 1.01 to 1.25. The target tooth condition or its magnification may include the shape, color, position, alignment, etc. of the tooth in question, e.g. the anterior tooth, canine tooth, etc. in question. The tooth veneer and/or the magnification may increase and/or ensure the stability of the device and is therefore a technical feature.

Thus, in one embodiment, the veneer may be a mock-up or an anticipation of the target tooth state. On the other hand, the veneer may also be designed according to other criteria, as already mentioned above. The dental veneer/veneering element may veneer a corresponding tooth when inserted into the person's mouth. For example, the veneer may comprise a recess for the tooth in question, in particular a recess with an alignment function or without an alignment function, i.e. depending on a treatment plan defined for the person. Alternatively, the dental veneer may also only partially enclose an associated tooth, e.g. only on the front side but not on the back side of the tooth.

Tooth veneers/veneering elements may also be used to which no tooth has yet been assigned, e.g. because the corresponding tooth is missing. In this case, the veneer may assume a support function on soft tissue or on an implant. These functions are explained in more detail below.

The at least one tooth veneer/veneering element may reproduce the physical outer contour in the target state of the tooth or a slight enlargement of the outer contour or the outer geometry. This may create corresponding sensory impressions in the mouth of the wearer of the devices, i.e. the person, e.g. on the inside of the lips or on the inside of the cheeks. This means that the person only has to get used to the target tooth arrangement once, which increases the person's acceptance of the large number of devices. If the target tooth arrangement is perceived as uncomfortable or unsuitable by the person even after familiarization, the target tooth arrangement may be corrected at an early stage, e.g. at the start of treatment or in the first third. User acceptance increases because the user may see or feel what the result will be at the end of a long treatment session right from the start.

The dentist and/or orthodontist and/or the person may recognize at any time from the position of the recesses in a device how far away the actual state of the teeth is from the target tooth state because, for example, distances from recesses to frontal target surfaces are reduced. The dentist or orthodontist may see how close the actual state is to the target tooth position by comparing the actual state of the teeth with the target tooth state represented by the dental veneer, particularly on the front surface of the dental veneer.

The outer surface of the tooth veneer may be designed like the outer surface of the target arrangement or only slightly different, e.g. also due to the enlargement to be taken into account and/or within the scope of the manufacturing tolerances and/or deviations smaller than 1 mm or smaller than 0.5 mm. If the tooth in question has reached its final position and is not to be changed by superstructures or attachments in a final treatment, a very thin tooth veneer may be used. Openings or breakthroughs in the tooth veneer may also be used to no longer veneer tooth surfaces that have reached their final position, but to arrange them so that they are freely visible from the front.

The device groups may comprise pairs of device. Alternatively, several devices may also be used for a lower jaw or for an upper jaw, for example a left device and a right device. In this case, the tooth veneer may be arranged in the canine (tooth) region, for example.

In particular, the following tooth veneers/veneers or anterior tooth replicas may be available:
a first upper anterior tooth veneer or anterior tooth replica (tooth body), e.g. of the upper left anterior tooth, e.g. as seen from the person, and/or
first lower anterior tooth veneer or anterior tooth replica (tooth body), e.g. of the lower left anterior tooth, e.g. as seen from the person, and/or
a second upper anterior tooth veneer or anterior tooth replica (tooth body), e.g. of the upper right anterior tooth, e.g. as seen from the person, and/or
a second upper anterior tooth veneer or anterior tooth replica (tooth body), e.g. of the upper left anterior tooth, e.g. as seen from the person.

The front side of the at least one tooth veneer may have the same position in all devices of the series or in at least half of the devices or device pairs of the series with respect to a cranial/facial feature of the person, in particular a facial feature defined by a cranial feature, i.e. in particular a feature that has been used to determine the target arrangement.

According to a further embodiment, when the pairs of devices are changed in the mouth of the person, the at least one tooth veneer of the second pair of devices may be in the same position in the mouth as the at least one tooth veneer of the first pair of devices.

A third pair of devices in the series may be lie in the sequence after the second pair of devices. The third pair of devices may also comprise at least one tooth veneer, which is designed like the at least one tooth veneer on the first pair of devices and/or like the at least one tooth veneer on the second pair of devices.

The sequence of the devices may be specified by a treatment plan. At the end of the treatment, only one device may be used instead of a pair of devices.

The device may or should remain in the mouth while eating. This makes it possible to enable the person to chew better right from the start. The mechanical stability of the device may withstand the chewing forces, which may be the case in particular with devices that have been milled out of a stable material, especially in comparison to devices/aligners that have been made from thin foils using the thermoforming process. After eating or at the usual tooth cleaning times, the devices or the currently worn device may be removed from the mouth and may thus be cleaned more easily, as may the teeth or remaining tooth structures.

Alternatively, the device may be removed from the mouth when eating.

The devices may be intended to be worn in the mouth for at least 15 hours, at least 20 hours a day or at least 22 hours a day when it is their turn.

According to another further embodiment, at least a subset of the devices/device pairs, at least half of the device pairs or all device pairs, in particular some of the upper jaw devices and/or some of the lower jaw devices may have been produced using a subtractive manufacturing process, i.e. a process in which material is specifically removed from the workpiece during production, or using an additive manufacturing process, i.e. a process in which material is specifically added to the workpiece during production. In the first pair of devices and/or in the second pair of devices, there may be undercuts that cannot be easily produced using a deep-drawing process, for example. Alternatively or additionally, there may be differences in material layer thickness in the center of occlusal surfaces of more than 2 mm or even more than 4 mm in a device or in a sub-device of a pair of devices in relation to an up-down direction of the person's head, i.e. a height direction, for example. This is also not easily possible with a thermoforming process in which a comparatively thin film is placed on a mold and then formed, e.g. by pressure, vacuum and/or using temperature, e.g. temperatures greater than 90 degrees Celsius or greater than 100 degrees Celsius.

A milling process may leave to the naked eye visible or only microscopically visible separation marks or milling marks. Polishing methods may be used to smooth the outer surface. A maximum layer thickness in the center of an occlusal surface may be at least 50 percent, at least 100 percent, at least 200 percent, at least 300 percent or at least 400 percent of a minimum layer thickness in the center of another occlusal surface of the same device, in particular the same lower jaw (mandibular) device or the same upper jaw (maxillary) device. Because the subtractive process allows the device to be produced directly, no further molds (negative) are required, as is the case, for example, with thermoforming.

3D (three-dimensional) printing processes are particularly suitable as additive manufacturing processes, e.g. photolithography, e.g. stereolithography, in which liquid photosensitive plastics are hardened layer by layer using light or laser in order to produce the devices of the series directly.

Health-compatible plastics are suitable as materials for the devices, e.g. synthetic resins such as acrylic resin, epoxy resin or vinyl ester resin, polyurethane PU, PMMA (polymethyl acrylate).

According to an embodiment, a first device, e.g. a first device pair, and a second device, e.g. a second device pair, or at least half of all devices/device pairs or all devices/device pairs may comprise at least one tooth veneer which causes alignment functions of teeth and shifting functions to be applied to the teeth of the person in a concealed area, i.e. largely invisible from the front, in relation to at least one dental arch of the person. Force-transmitting functional elements may press the teeth in corresponding directions, e.g. functional elements that interact with attachments on the teeth or that act directly on the teeth, e.g. protrusions or active surfaces in recesses for the teeth. At least one of the two tooth arches of the person may be brought into a new constellation, e.g. while the position of the tooth veneers visible from the front remains the same or changes only insignificantly, preferably in the course of the entire series or in the course of a longer section of the series comprising at least 20 percent of the devices, e.g. at least 5 devices, with a total deviation of less than 0.6 mm or less than 0.4 mm. The alignment functions and/or shifting functions may carry out the incremental changes between successive steps of the series at receiving regions or recesses for the teeth in the devices/device pairs, while the areas concerned are covered from the front by the veneer element or the tooth veneer.

The dental veneer can, for example, be arranged at at least two, at least three, at least four, at least five or at least six tooth positions, for example at at least one anterior tooth position at two anterior tooth positions and/or at at least one canine tooth position.

According to an embodiment, a combination of superstructures with height function and superstructures with sliding function and/or a combination of superstructures with height function and superstructures with “upper jaw”-“lower jaw” relative positioning function or with ramp function may be formed in at least a subset of the devices in the molar regions of the upper jaw device and/or the lower jaw device such that they achieve a displacement of the contact plane and the future chewing plane relative to the initial state of the treatment and, in particular, a cranial and/or facial optimization (with respect to the person's face) of the masticatory/chewing apparatus. The superstructures may have a layer thickness/height towards an occlusal surface that is at least 2 mm, at least 3 mm or at least 4 mm. Such layer thicknesses/heights or the layer thickness differences to other regions of the same lower jaw device or the same upper jaw device that may be associated therewith may advantageously be produced using subtractive or additive manufacturing processes.

According to an embodiment, at least a subset of the devices may have a coloring of a color function on at least a subset or all of the veneering elements or tooth veneers of the devices visible from the front.

The coloring may preferably be achieved as an effect of the material selection or by a coating, e.g. a lacquer-like coating, of the outer material layer of the pairs of devices or at least a subset of the devices. The coloring may comprise a white component and/or a yellow component. The coloring may differ from a transparent and/or translucent coloring. The coloration may be an aesthetically pleasing coloration. However, translucent layers may reinforce the impression that the teeth are natural. The coloring may be carried out with a health-compatible color, e.g. with a colorant that is also used or may be used for coloring food.

According to an embodiment, at least one device, e.g. a jaw device, or a pair of devices of the series, preferably a pair of devices of the first 20 percent of the series, may each have at least one designed veneering element/tooth veneer or tooth veneers which completely or largely cover the teeth and/or tooth stumps of the person in the area visible from the front, in order to carry out displacements on these teeth and/or tooth stumps behind them in the concealed area, which preferably consist of superpositions of translation and rotation in steps, in order to guide the teeth and/or tooth stumps in the concealed area to the target position. In this way, the veneering element or the dental veneer may conceal these processes in addition to its stabilizing function when viewed from the front. By concealing/veneering, the processes may be made largely invisible to third parties.

According to an embodiment, at least a first subset of the devices may be configured in such a way that a height build-up or superstructure is first carried out on the person's molars by means of a height function. The height superstructure may be suitable for increasing the distance of the lower jaw from the upper jaw in the contact bite and thereby lead to an unblocking of previously blocked tooth displacements. At least one further subset of the pairs of devices, in particular a subset which differs from the first subset, may be designed in such a way that this unblocking (release), which has been achieved in particular by height functions, is followed by a tooth displacement of teeth or tooth stumps of the person by aligner functions as part of the subsequent devices/pairs of devices and/or a change in the dental arch of the person by shifting functions as an additional part of the subsequent devices. The tooth displacements may be suitable for bringing the person's dentition closer to the target arrangement or to intermediate target tooth arrangements.

According to an embodiment, height functions may also be combined with sliding functions in at least a subset of the devices, e.g. the pairs of devices, in addition to alignment functions and/or shifting functions. For example, at least a subset of the pairs of devices may have sliding surfaces on the right and left which are smooth and/or not keyed at least in some regions, so that they lead to a neuromuscular stabilization requirement of the lower jaw relative to the upper jaw in this region when an active contact force is exerted by the wearer of the devices or by the person. The requirement for stabilization may lead to an actual neuromuscular relearning of the position of the chewing plane in the person.

Although mutually facing sliding surfaces of the upper jaw device and the lower jaw device may be complementary to each other, there may be asymmetries between the left and right elements defining the overall sliding surface, e.g. mutually different height superstructures. Keyed may mean that there are elevations and depressions whose height corresponds to the height of natural tooth pits or cusps. Right-left symmetrical elements may also be used to define the overall sliding surface.

According to an embodiment, in addition to alignment functions relating to individual teeth of the person and/or shifting functions relating to the dental arch of the person, ramp functions may also be integrated in at least some of the devices or pairs of devices. In particular, the ramps in question may have vertical or primarily vertically oriented ramp surfaces. Transversely lying surfaces of the ramps or primarily transversely lying surfaces may enable the required distance between the lower jaw and the upper jaw. The ramp functions may be suitable for generating a lateral reaction force under contact force between the lower jaw and upper jaw as a result of the locally viewed, e.g. inclined plane at a ramp, which moves the lower jaw relative to the upper jaw in at least one of the combined transverse directions right-left and/or back-front. This may allow a change in the position of the lower jaw relative to the upper jaw to be achieved, whereby the dental arch of the lower jaw and/or the upper jaw does not have to be changed but may be changed if necessary.

According to an embodiment, the last device or the last pair of devices of the series may be configured in such a way that the most accurate possible, e.g. taking into account the enlargement and/or manufacturing tolerances, or an reproduction of the planned final restoration or the target tooth state or the target tooth arrangement is achieved, e.g. in order to bring the treatment to completion by means of devices of the series. Alternatively or additionally, intermediate target tooth states may also be used. The final restoration may be reproduced at least in the visible anterior region using anterior veneering elements or anterior tooth veneers, which are preferably shaped according to the planned final restoration and may optionally be dentally colored or stained according to the planned final restoration using color functions. The anterior veneering elements or anterior tooth veneers may then be replaced in the final restoration, for example with a permanent or fixed restoration, e.g. to complete the overall treatment. The following elements may be used: Table top (height build-up/superstructure), onlay (with grinding of the tooth surface), veneer (anterior veneer), crown, bridge, implant, in particular also combinations of the aforementioned elements, etc. Blocking over several teeth should be avoided as far as possible in the final restoration, as this may be disadvantageous because, for example, it may lead to damage to the fine retaining fibers (Sharpey fibers) of the teeth.

An “reproduction that is as accurate as possible” can, for example, again mean “within the manufacturing tolerances” and/or taking into account the magnification, as already explained above and/or taking into account the dental technical conditions.

According to an embodiment, the last device or the last pair of devices of the series may be designed in such a way that the planned final restoration of the person's teeth is reproduced as accurately as possible, with the final restoration being reproduced at least in the molar region by molar elements, in particular molar veneering elements or groups of such elements, for example in order to complete the treatment by means of devices of the series. Alternatively or additionally, intermediate target tooth states may also be used. These molar elements (groups) may have an chewing surface geometry and an orientation of the chewing surface corresponding to the planned final restoration or the intermediate target tooth states, for example based on a cranial geometry and/or anatomy of the person's skull. These temporary molar elements (tooth veneers) in the molar region may also be replaced by dentures, for example, in the final restoration.

A medical imaging method may be used taking into account the bone density, e.g. radiographic density. Segmentation may be performed, for example, using the Hounsfield X-ray density units to determine, for example, cranial features such as eye sockets and/or inner ear, see, for example, Hornung (EP 3 332 731 A1) and Saxler WO 2020/141134 A1, which are hereby incorporated by reference for all legal purposes.

In particular, the aim may also be to change the position of the chewing/masticatory plane permanently, i.e. even after the final restoration, especially with regard to its inclination in a frontal plane and/or with regard to the inclination in a sagittal plane and/or in its height position.

According to an embodiment, a height profile element or a material thickening, i.e., for example, a protrusion, in particular of solid design or partially hollowed out on the inside, may be present on occlusal surfaces in at least a subset of the device pairs, which is at least twice as high as the layer thickness/height on other occlusal surfaces of the same upper jaw device or the same lower jaw device. The total layer thickness/height in the region of the height profile element/material thickening may preferably be greater than 2 mm or greater than 3 mm or greater than 4 mm. In other areas of the device, the maximum layer thickness of occlusal surfaces or the height of the height profile element may, for example, be less than 2 mm or even less than 1 mm. A height profile element or the material thickening may preferably be present in the first pair of devices and/or in at least one pair of devices of the first 20 percent of the devices in the series.

The height profile element may be created by thickening the material, i.e. by using more material compared to other regions. Alternatively, however, cavities may also be used to realize the height profile element, which have the same function as material thickenings made of solid material. The cavities may be realized, for example, between occlusal surfaces and an inner side of an occlusal wall/ceiling facing the occlusal surfaces, e.g. in the case of a height profile element on a lower jaw (mandibular) device, or wall/bottom of the height profile element, e.g. in the case of a height profile element on a lower jaw (mandibular) device.

According to one embodiment, in particular a height jump (increase) of the height profile element or the thickening compared to the previous device or compared to a starting state of the person's teeth may be used. The height jump (increase) of the height profile element or the thickening may be in the range of 3 mm to 6 mm.

According to an embodiment, in the same upper jaw device or the same lower jaw device, there may be left and right height profile elements or thickenings with different heights in the same molar positions. The difference in height may preferably be at least 1 mm (millimeter), at least 2 mm or at least 3 mm. This may allow asymmetries in the person's chewing apparatus to be taken into account, e.g. to reduce or eliminate them. The asymmetry of the height profile element or the thickenings may also cause the person's lower jaw to rotate relative to their upper jaw. Alternatively, left and right height profile elements or thickenings of the same height may be used, i.e. right-left symmetrical height profile elements/thickenings.

The right-left system of the wearer of the device pairs may be used as the reference system. Alternatively, the right-left system of the frontal observer may also be used, e.g. dentist, technician, orthodontist.

According to one embodiment, the first anterior tooth veneer of the first device or of the first pair of devices may comprise a first recess/receiving region for an anterior tooth of the person. A first anterior tooth veneer of the second device or of the second pair of devices may comprise a first recess/receiving region for the same anterior tooth of the person. At least the labial outer surfaces of the first anterior tooth veneer of the first device may be shaped the same as the labial outer surfaces of the first anterior tooth veneer of the second device, or only insignificantly different from this outer surface. The first recess of the first anterior tooth veneer may have a first position with respect to the labial outer surface of the first anterior tooth veneer. The first recess of the second anterior tooth veneer may have a second position with respect to the labial outer surface of the second anterior tooth veneer. The first position may differ with respect to the second position due to translation of a tooth of the person along a front-back axis with respect to the head of the person. The first anterior tooth veneer of the first device may have a first material thickness in the labial direction, in particular in the region of the first recess/receiving region. The first anterior tooth veneer of the second device may have a second material thickness in the labial direction, in particular in the area of the first recess, preferably measured at the same position in the second device/the second pair of devices in relation to the measurement position of the first material thickness in the first device/the first pair of devices. The first material thickness may deviate from the second material thickness by at least 20 percent or at least 50 percent. This may be a direct consequence of the fact that the anterior tooth veneer remains essentially unchanged in its frontal area, but the translation of the anterior tooth takes place behind it, e.g. from back to front or from front to back. The same may also apply to a posterior-anterior tilt or twist (rotation) of the anterior tooth, i.e. a change in the layer thickness on the front of the anterior tooth veneer.

The change in the thickness of the material layer at the front may be compensated for by an opposite change in the thickness of the material layer at the rear of the dental arch, for example to maintain the overall stability of the device unchanged. This means that the layer thickness in the rear area of the dental arch may be increased if the layer thickness in the front area is reduced and vice versa. However, the material layer thickness in the rear area may also remain unchanged, e.g. depending on dental-technical or other conditions.

According to one embodiment, the upper jaw device of the first device or of the first pair of devices or the lower jaw device of the first device or of the first pair of devices may carry at least one second anterior tooth veneer on its front side, which is adjacent to a first anterior tooth veneer of the first device or of the first pair of devices, for example the above-mentioned first veneering element. The upper jaw device of the second device or of the second pair of devices or the lower jaw device of the second device or of the second pair of devices may carry at least one second anterior tooth veneer on its front side, which is adjacent to the first anterior tooth veneer of the second device or of the second pair of devices, e.g. the above-mentioned second veneering element.

The following may also apply to a total of four recesses/receiving regions:
wherein the first anterior tooth veneer of the first device comprises a first recess for a first anterior tooth of the person or is adjacent to a first recess/receiving region,
wherein the second anterior tooth veneer of the first device comprises a second recess for a second anterior tooth of the person or is adjacent to a second recess/receiving region, wherein the second anterior tooth is adjacent to the first anterior tooth,
wherein the first anterior tooth veneer of the second device includes a first recess for the first anterior tooth of the person or is adjacent to a first recess/receiving region, and
wherein the second anterior tooth veneer of the second device comprises a second recess for the second anterior tooth of the person or is adjacent to a first recess/receiving region.

The two anterior tooth veneers of the first device may be the same at least on occlusal surfaces and/or on labial surfaces as the two anterior tooth veneers of the second device. Equality may exist with regard to the maximum width of an occlusal surface and/or the maximum width of a labial surface and/or the distance of the adjacent occlusal surfaces from one another and/or the distance of the adjacent labial surfaces from one another. This equality may be due to the fact that the outer contour or outer geometry of the dental veneer(s) does not change, in particular in its front region.

The two recesses of the first pair of devices may have a first distance from each other, in particular a minimum distance. The two recesses of the second pair of devices may be a second distance apart, in particular a minimum distance. The size of the first spacing may differ from the size of the second spacing by at least 20 percent or at least 50 percent. The first distance may differ with respect to the second distance due to a translation of the first anterior tooth of the person along a right-left axis with respect to the head of the person and/or a translation of the second anterior tooth of the person along the right-left axis. Preferably, this translation or these translations may also cause an increase or decrease in the distance between the two anterior teeth of the person.

As mentioned above, the anterior veneer/veneering element may remain unchanged, particularly in its frontal contour/geometry. Nevertheless, the distance between the recesses may change. The change in the distance between the recesses may in turn be a direct consequence of the fact that the anterior veneer remains essentially unchanged in its frontal area, but the translation of the anterior tooth or teeth takes place behind it. The translation may, for example, take place to the right or to the left or one tooth may be moved to the right and the other tooth to the left. This may close a gap between the two front teeth or increase the distance between the two front teeth. The same may also apply to a right-left tilt or twist (rotation) of the anterior tooth or teeth, i.e. changing the distance between recesses in the anterior veneer, the outer contour of which may remain unchanged.

Here too, the overall stability of the device may be maintained if the stability is reduced by reducing the distance between the recesses, but the stability is increased again by adding appropriate material in other areas, e.g. in the lateral areas of the recesses of the device or the tooth veneer(s).

According to another embodiment, at least one device/device pair or at least two devices/device pairs, at least three devices/device pairs or at least four devices/device pairs or at least 10 devices/device pairs may be located between the first device or the first device pair and the second device or the second device pair in the sequence of the devices of the series. Preferably, this allows the difference in material layer thicknesses and/or the difference in the spacing of recesses across several devices to be changed significantly and thus easily measurable or easily detectable, e.g. by at least 0.5 mm or at least 1 mm or at least 2 mm.

According to an embodiment, the at least one veneering element or the at least one tooth veneer or the veneering elements/tooth veneers may homogeneously comprise a single material in at least some of the devices/device pairs or in all devices/device pairs. This may simplify production.

According to an alternative embodiment, in at least some of the devices/device pairs or in all devices/device pairs, the at least one veneering element or the at least one tooth veneer or the veneering elements/tooth veneers may each comprise at least two different materials from one another. Thus, there may be a first material in an outer area and a second material in an inner area of the tooth veneer(s) enclosed by the outer area. The first material may have a greater hardness than the second material. Alternatively, the second material may have a greater hardness than the first material. There are standardized methods for determining the hardness, e.g. for determining the Shore hardness, in particular using scale A or scale D. Alternatively, non-standardized methods may also be used to determine the hardness.

If the harder material is used for the outer area (first material) of the dental veneer(s), abrasion may be reduced, for example, and wearing comfort may be increased by the softer inner material.

The softer material may be used in the outer area of the dental veneer(s) if there are medical or other reasons for this, for example.

According to a further embodiment, the material in the inner region may extend over several tooth positions or over the entire dental arch of a partial device of a pair of devices. The outer region may be configured to be used successively for at least two different inner areas. For example, the outer area may be used for at least 20 percent of the devices. A mechanical interface, e.g. in the sense of an interface, may be defined between the inner region and the outer region, which is the same for at least two pairs of devices. The inner region may be insertable into and/or removable from the outer region, in particular using a form fit and/or a force fit. Alternatively, additional fastening elements may be used. This modular system may significantly reduce manufacturing costs and the overall cost of manufacturing the devices in a series may be significantly reduced.

According to an embodiment, in relation to proximal free ends of a lower jaw (mandibular) device of the respective device/the respective pair of devices, the labial outer surface of the first tooth veneer may have a different position in a sagittal sectional plane than the labial outer surface of the second tooth veneer due to a widening of the dental arch. The difference in position may be at least 1 mm or at least 1.5 mm. Nevertheless, the position of the front side of the dental veneer in relation to a cranial reference system may be essentially the same.

According to an embodiment, e.g. with widening of the dental arch, there may be no devices or no device pair between the first device/first device pair and the second device/second device pair in the order of the devices of the series at least one device/device pair, or there may be at least two devices/device pairs, at least three devices/device pairs or at least four devices/device pairs or at least 10 devices/device pairs. The total difference in position over several devices may be at least 0.5 mm or at least 1 mm or at least 2 mm.

According to a further aspect, a method for designing dental devices is disclosed, in particular polyfunctional devices. The method may in particular be suitable for designing the above-mentioned series or a series according to one of the above-mentioned further embodiments, wherein digital data may be generated. The designing may be a preliminary stage for manufacturing the device(s).

The method may include:
Capturing/Recording a starting tooth arrangement of a person's teeth in the person's upper jaw and/or the person's teeth in the person's lower jaw, preferably together with at least one cranial feature and/or facial structure/feature in the person's cranial region,
Determining at least one reference structure of the person before, during or after the recording, preferably a cranial reference structure,
Determining a target tooth arrangement of the teeth of the person's upper jaw, taking into account the reference structure, in particular with regard to the upper jaw or a target upper jaw of the person,
Determining a target tooth arrangement of the teeth of the person's lower jaw, taking into account the reference structure, in particular with regard to the person's lower jaw or a target lower jaw.
based on the starting tooth arrangement and the target tooth arrangements, or a target shape and/or target position of the target upper jaw and/or the target lower jaw, providing a data set series consisting of digital data set groups following one another in a sequence, in particular of digital data set pairs, for example each with a data set for the teeth of the upper jaw and/or a data set for the teeth of the lower jaw.

The method may use the technical features specified in claim 1 or the features specified in claims 1 to 20.

The target tooth arrangement may be used as the basis for the production of at least one veneering element/tooth veneer, in particular an anterior tooth veneer, possibly also including a canine tooth veneer or further veneers/veneering elements for other teeth, e.g. premolars or molars.

According to a further embodiment, the at least one veneering element or the at least one tooth veneer may represent the tooth located at this tooth position in a target tooth state or intermediate target tooth state or in a suitable magnification of the target tooth state or intermediate target tooth state. With regard to the extent of the magnification, the above-mentioned range may also apply to the method.

According to a further embodiment, the at least one veneering element or the at least one tooth veneer may be used for designing at least one device or a plurality of devices of a series of devices for incrementally changing the position of the person's teeth. The at least one device may differ from a last device of the series or the several devices may differ from a last device of the series.

Thus, the technical effects mentioned above for the at least one dental veneer of the series of devices may also indirectly apply to the method for designing the devices comprising the at least one veneering element or the at least one dental veneer, i.e. that there is the possibility that, for example, the target tooth state may thus already be used or represented beforehand.

Suitable methods may be used to provide the data, e.g.:
Collision detection using OBB (Oriented Bounding Box) trees/graphs (Trees), and/or
Visualization of three-dimensional structures using Voroni diagrams.

Recording the starting tooth arrangement of the teeth may also include taking a bone image of a patient's head that also shows the location of the lower jaw in a lower jaw (mandibular) starting position, the upper jaw in an upper jaw starting position, and of the teeth of the upper jaw and of the teeth of the lower jaw in a starting tooth position.

Determining the reference structure may include determining at least one reference plane involving at least one cranial structure/structural feature of the bone structure of the person's (patient's) head or a facial structural feature of the person's face, the facial feature preferably being closely associated with a skull structure.

Consideration of the cranial feature may be a prerequisite for long-term treatment success. The cranial structure is in particular a structure outside the upper jaw and/or in particular also outside the person's lower jaw. The cranial structure may be:
related to a feature of the skull and/or head, e.g. the temples, the ears, the inner ear areas, the eye sockets, the zygomatic bones, etc.
be suitable for defining a sagittal plane, e.g. a medial sagittal plane through the skull, in particular at the halfway point between paired features, i.e. e.g. exactly between the determined inner ear regions or between other features mentioned above, etc.
be suitable for defining an essentially transverse plane, e.g. a target chewing plane, see e.g. EP 33 32 731 A1, which is hereby incorporated by reference for all legal purposes.

The reference structure may include, for example, the Cartesian reference plane system proposed in WO 2020/141134 for a training device, but which may also be used for other purposes, e.g. for the proposed method. Document WO 2020/141134 A1 is hereby incorporated by reference into the present text for all legal purposes.

If, for example, the sagittal plane is known, the planes orthogonal to it may be defined, e.g. at least one frontal plane or a frontal plane package and/or at least one transversal plane or a transversal plane package.

There may be at least 10, at least 20 or at least 30 devices in the series. There may be less than 100 devices in the series. The exact number of devices may be specified in a treatment plan and may depend, for example, on whether or not attachments are used or what pressure on their teeth the person concerned still finds acceptable.

In one embodiment, the method may also include at least one of the following steps:
Determination of force vectors required to displace the teeth, e.g. using FEM (Finite Element Method) or FDM (Finite Difference Method) or other suitable methods, which may be computer-based,
based on the force vectors, determining the shape of recesses and/or force-transmitting elements (attachments and/or protrusions and/or active surfaces in recesses) in devices of a series comprising at least two pairs of devices.

The devices relevant for the method may also be configured like the above-mentioned devices, i.e. each comprising, for example, an upper jaw device and a lower jaw device. The devices or the device pairs of the devices may be configured, taking into account the force vectors, in such a way that they cause an incremental change in the position of the person's teeth one after the other according to a sequence of the devices/device pairs.

The attachment of attachments to the teeth may play an important role in the success of the treatment. The attachments may be small fastening elements made of composite, i.e. a tooth-like substance, compared to the teeth, which ensure that tooth movement may take place more quickly, easily and efficiently. The attachments may act as an anchor that the aligner grips to accomplish the movement, e.g. lifting the teeth. Attachments allow the necessary pressure for tooth movement to be applied precisely. In addition, the attachments may enable complex movements such as the rotation of the teeth and ensure that the correction takes place without unnecessary “intermediate movements”.

In principle, treatment may also be carried out without attachments. For some misalignments, attachments are simply not required and/or may be omitted or scheduled for a later date if desired. Treatment without attachments may result in more dental splints being required to achieve the target alignment.

Each digital data set or each digital data set pair may comprise:
Data describing a tooth arrangement of the teeth of the upper jaw, and/or
Data describing the arrangement of the teeth of the lower jaw.

Successive tooth arrangements of the upper jaw may progress incrementally from an initial tooth arrangement of the teeth of the upper jaw to a final or target tooth arrangement. Successive tooth arrangements of the lower jaw may progress incrementally from an initial tooth arrangement of the teeth of the lower jaw to a final or target tooth arrangement.

According to an embodiment, the method may preferably be used to treat misalignments and/or signs of ageing in a person's dentition. Other applications are also possible.

According to a further embodiment, a polyfunctional overall treatment plan may be created that integrates a variety of functions into the devices of the series. Each of the functions may comprise a partial treatment plan relating to the individual teeth or tooth positions of the person's dentition.

The overall treatment plan may describe which of the polyfunctional functions are activated when and/or to what extent, whereby at least two, at least three, at least 4, at least 5 or at least 6 function types may be selected and integrated from the group:
Alignment function, at least a subset of the devices or all of the devices displacing at least one tooth by small incremental shifts, small incremental tilts or small rotational increments, wherein the increments preferably being less than 0.3 mm (millimeters) or less than 0.2 mm, and/or
Shifting function, wherein a large-scale shifting of teeth by tilting and translation and optionally inclination correction for displacing or changing the dental arch is effected by at least a subset of the devices or by all devices, wherein the dental arch is displaced by at least 1 mm or by at least 2 mm or extended by at least 1 mm or by at least 2 mm, and/or,
Shape function, wherein the shape of at least a subset of the devices or all of the devices of the series is designed with aesthetically designed tooth veneers preferably arranged in the perceptible front region and/or in the visible region, wherein preferably the tooth veneers cover teeth or tooth stumps, and/or
Color function, wherein at least a subset of the devices or all devices in or on at least front-visible tooth veneers of the device pairs have an individual color, in particular the color of the person's teeth or another appealing tooth color, e.g. an aesthetically appealing, in particular a color different from a colorless translucent or colorless translucent material, and/or
Height function, wherein a solid superstructure/build-up with material over the molars in molar regions of the devices or a subset of the devices takes place, preferably with a layer thickness of at least 2 mm or at least 3 mm or at least 4 mm, and/or
Sliding function, whereby an e.g. solid superstructure with a formed sliding surface is used in at least a subset of the devices, preferably with a layer thickness/height of at least 2 mm or at least 3 mm or at least 4 mm and/or with low friction and/or without retentions (recesses, indentations, profile), and/or
Upper jaw/lower jaw relative positioning function, preferably a ramp function, wherein in at least a subset of the devices locally incorporated ramps, slopes, springs or other element are used which cause a transversal reaction force upon contact between upper jaw and lower jaw, and/or
Implant function, which in at least a subset of the devices have a supporting function and/or fixing function and/or positioning function of an upper jaw device or a lower jaw device of a pair of devices on implants of the person, wherein preferably the implant is predominantly axially loaded, and/or
A carrier function that provides a carrier function for a upper jaw device or a lower jaw device of at least one of the devices on soft tissue of the person in at least a subset of the devices or in all pairs of devices, especially when teeth are missing at important locations in the dental arch.

Further functions may optionally be added, e.g. an orthosis function, e.g. an orthosis according to Saxler, see WO 2020/141134 A1, which is hereby incorporated by reference for all legal purposes. The separation slide plane of the orthosis may be determined according to Saxler (3D structure marking/marker/ruler) or according to another method. The orthosis may or may not comprise an edge gap.

In at least one section of the series, the orthodontic alignment function and the esthetic shape function may be used simultaneously and integrated in the devices.

At least one or more of the further embodiments already described above for the series may also apply to the method:
force-transmitting functional elements for alignment functions and shift(ing) functions are covered by the at least one tooth veneer,
a combination of superstructures with height function and superstructures with sliding function and/or a combination of superstructures with height function and superstructures with ramp function, in particular in molar regions of the upper jaw device and/or the lower jaw device,
Coloring,
at least one of the first 20 percent of the devices in the series comprises shaped tooth veneers,
First a height superstructure/build-up is carried out using a height function, then suitable tooth displacement using alignment function(s) and/or tooth arch modification using shifting function(s),
In addition to alignment functions and or shifting functions, height functions with sliding functions,
In addition to alignment functions and/or shifting functions, also upper jaw/lower jaw relative positioning function (e.g. ramp function),
the last pair of devices in the series is the most accurate possible reproduction of the planned final restoration in the visible anterior tooth region, and/or
The last pair of devices in the series is the most accurate possible representation of the planned final restoration of the person's teeth in the molar region.

According to a further embodiment, a final restoration of the person's teeth and/or tooth stumps may be carried out after the last pair of devices has been worn in accordance with a treatment plan. The final restoration may create a permanent chewing/masticatory surface that matches a planned chewing surface. The final restoration may create an anterior surface that matches the planned anterior surface, in particular the shape and/or position of the labial outer surfaces of the at least one anterior tooth veneer and/or the shape and/or position of a labial outer surface of a second anterior tooth veneer.

According to a further aspect, a manufacturing method is disclosed which may be used to manufacture the above-mentioned series and/or which is based on the devices of the series designed according to one of the above-mentioned methods. Thus, the above-mentioned technical effects may also apply to the manufacturing method. A subtractive manufacturing process may be used to manufacture the series of devices or pairs of devices or at least to manufacture part of the devices, e.g. more than half of the devices. A subtractive machining process may be used, in particular milling. Alternatively, an additive manufacturing process may be used, in particular 3D (3 -dimensional) printing. The above-mentioned technical effects of these processes also apply here, e.g. simple or simpler production of undercuts and/or different layer thicknesses in the center of occlusal surfaces.

All devices may be produced at the same production site, e.g. on the same machine. This may facilitate logistics, for example. Alternatively, a first part of devices may be produced at a first manufacturing location and a second part at a second manufacturing location, e.g. to ensure rapid availability of the first device and possibly one or two further devices on the one hand and to reduce the overall manufacturing costs by using low-cost manufacturing on the other. Furthermore, conventional deep-drawing processes may also be used to manufacture some of the devices in the series if the devices in question may be produced using this technology, e.g. if the shape function (tooth veneer) is not yet integrated.

According to a further aspect, the following units are specified:
a computer comprising: at least one storage unit, and

A control unit adapted to execute instructions of a program that causes the computer to perform at least part of one of the above-mentioned methods, in particular the steps related to the design of the devices, in particular in an automated or semi-automated manner,
a computer program comprising machine-readable instructions which, when executed by a control unit, cause the control unit to perform at least a part of one of the methods specified above,
a computer program product comprising machine-readable instructions which, when executed by a control unit, cause the control unit to perform at least part of one of the above methods, and/or
digital data generated by a method mentioned above or required by such a method, in particular design data and/or manufacturing data for manufacturing the device pairs with a manufacturing machine.

According to another aspect, digital data is provided for describing a series of devices for incrementally changing the position of a person's teeth. The digital data may describe devices or pairs of devices, each comprising an upper jaw device and/or a lower jaw device.

The upper jaw devices may be designed so that they may be placed on the dental arch in the person's upper jaw. The lower jaw devices may be designed so that they may be placed on the dental arch in the person's lower jaw.

The devices or pairs of devices may be designed in such a way that when they are worn by the person one after the other according to a predetermined sequence of the devices or pairs of devices, they cause an incremental change in the position of the person's teeth.

The digital data may preferably describe at least a first tooth veneer or a veneering element on the front side of an upper jaw device of a first device or of a first pair of devices or of a lower jaw device of the first device or of the first pair of devices.

The digital data may preferably describe at least a second tooth veneer on the front side of an upper jaw device of a second device or of a second pair of devices or of a lower jaw device of the second device or of the second pair of devices.

Similarly, a third tooth veneer/veneering element of a third pair of devices or a third device may also be described.

The at least one tooth veneer of the first device or the first pair of devices may be located at the same tooth position as the tooth veneer of the second device or the second pair of devices. Furthermore, the digital data may represent the technical features claimed in claim 1 or the technical features specified in claims 1 to 20.

The at least one tooth veneer of the first device or of the first pair of devices and the at least one tooth veneer of the second device or of the second pair of devices may represent the tooth located at this tooth position in a target tooth state or in an enlargement of the target tooth state.

According to a further aspect, a treatment plan is disclosed, in particular a digital treatment plan for incrementally changing the position of a person's teeth, in particular using a series according to any one of claims 1 to 20 or using a method according to any one of claims 21 to 33.

The treatment plan may describe the course of the person's treatment. The treatment plan may specify the following data in at least one section or throughout the entire treatment plan:
Number of a device or a pair of devices in the series,
Identification of the tooth position within the respective device or the respective pair of devices, and
Determination of the treatment function for the respective tooth position of the respective device or the respective pair of devices,
   wherein the treatment plan comprises a shape function as a treatment function, which determines the shape of at least two tooth veneers or at least three tooth veneers, in particular of anterior tooth veneers, and wherein at least one tooth veneer of a first device or of a first pair of devices is located at the same tooth position as the tooth veneer of a second device or of a second pair of devices and/or the tooth veneer of a third device or of a third pair of devices.

The treatment plan may reproduce the technical features claimed in claim 1 or the technical features specified in claims 1 to 22.

The at least one tooth veneer of the first pair of devices and the at least one tooth veneer of the second pair of devices or also the at least one tooth veneer of the third device or of the third pair of devices may represent the tooth located at this tooth position in a target tooth state or in an enlargement of the target tooth state.

This means that specifications may be made in at least three “dimensions” in the digital treatment plan, i.e. device number, tooth position and treatment function.

The treatment plan may comprise data sets or be based on a database, in particular a relational database. Alternatively, the digital data or the digital treatment plan may also be described in another suitable way.

The digital treatment plan may, for example, be suitable for submission to dental or other medical insurance companies.

For the digital data and the digital treatment plan, the technical effects specified above for the series and the method or the other aspects may also apply.

Although the invention has been illustrated and described in more detail by the preferred embodiment, the invention is not limited by the disclosed examples and other variations may be derived by the person skilled in the art without departing from the scope of protection of the invention.

Identical reference signs refer to identical technical features, unless otherwise stated. Where “may” is used in this application, it means both the possibility of realization and the actual technical implementation. The concepts of the disclosure are described with reference to preferred embodiments below in a specific context, namely aligners. However, the disclosed concepts may also be applied to other situations and/or arrangements, in particular to situations where no alignment is required.

The foregoing has broadly explained the features and technical effects of the invention. Additional features and technical effects of embodiments of the present disclosure are explained below, e.g. the subject matter of the claims. It should be recognized by those skilled in the art that the concept and specific embodiments may be used as a basis for modifying or designing other structures or processes having the same or similar purposes as the concept specifically disclosed herein. It should also be recognized by those skilled in the art that equivalent constructions do not depart from the spirit or scope of the disclosure as defined, for example, in the appended claims.

For a more complete understanding of the disclosed concepts and their technical effects and advantages, reference is now made to the following description in conjunction with the accompanying figures. The following figures are roughly schematic representations of complex polydimensional processes and polyfunctional devices. In principle, these illustrations may only represent a partial aspect of the illustrated reality of the devices and processes.

The figures are not drawn for scaling. The drawings show:

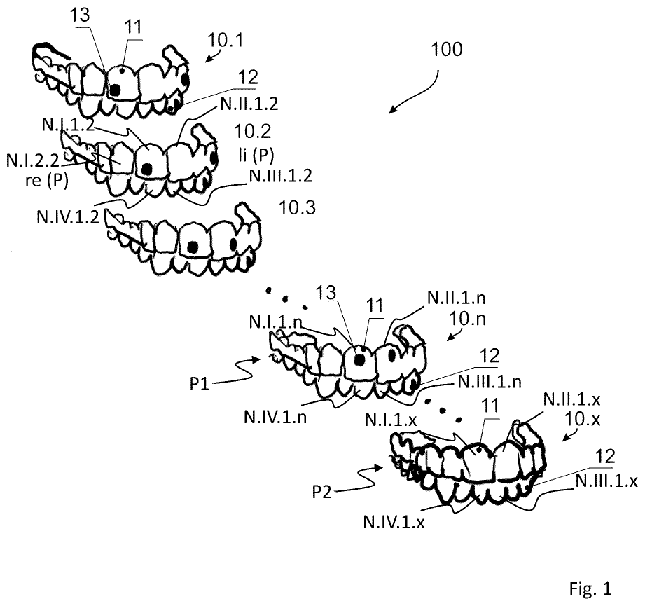

FIG. 1 a simple combination of aligner functions with a shape function and/or an optional color function,

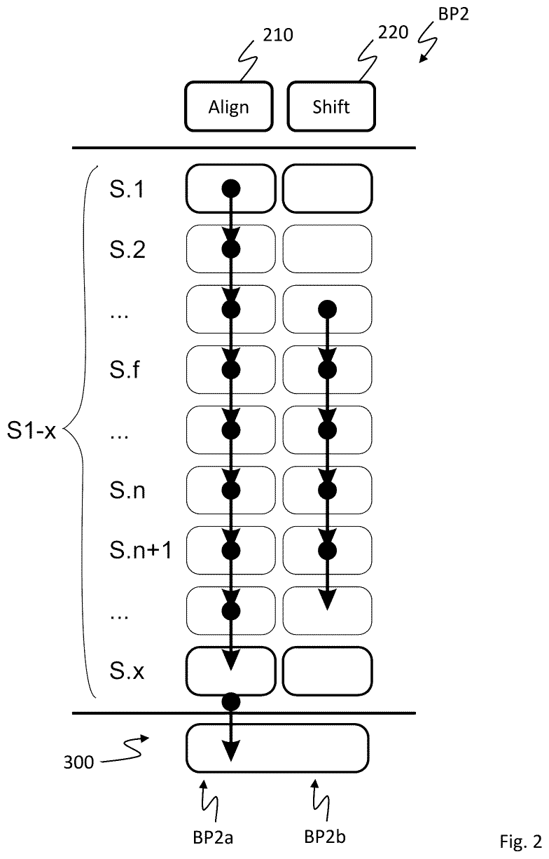

FIG. 2 a two-dimensional treatment plan for comparison, composed of alignment function and shifting function,

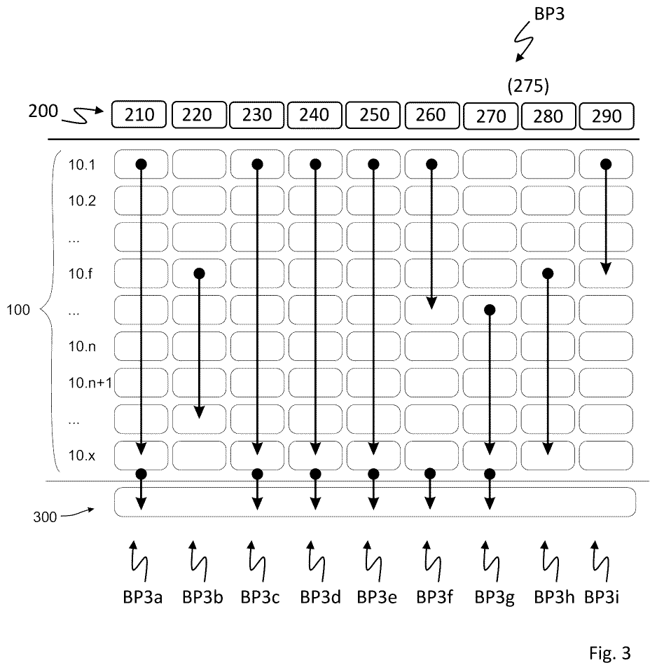

FIG. 3 a complex multifunctional treatment plan with 9 function types,

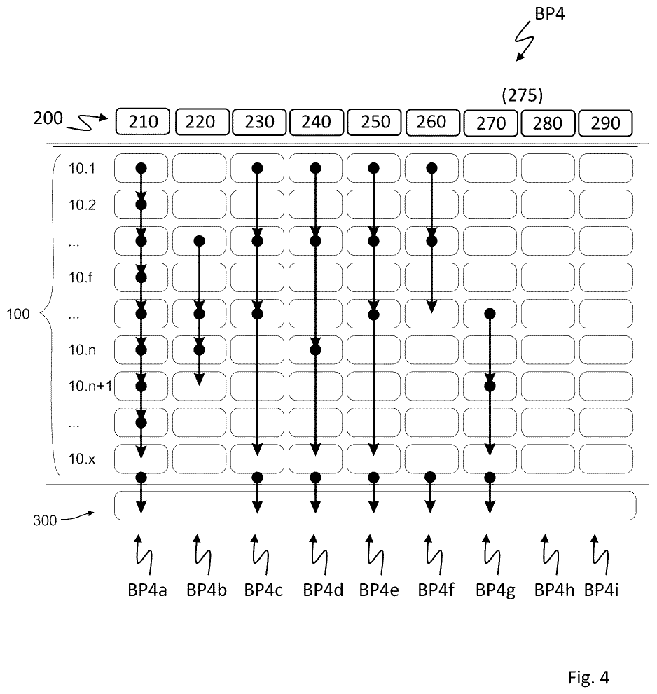

FIG. 4 the polyfunctional “staging” in the polyfunctional treatment plan,

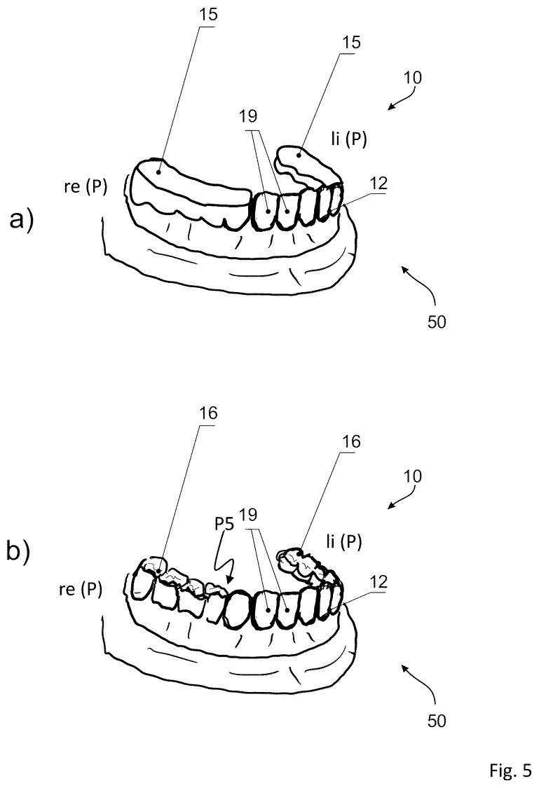

FIG. 5 an embodiment with sliding function in combination with height function on the molar regions and shape function on the anterior regions,

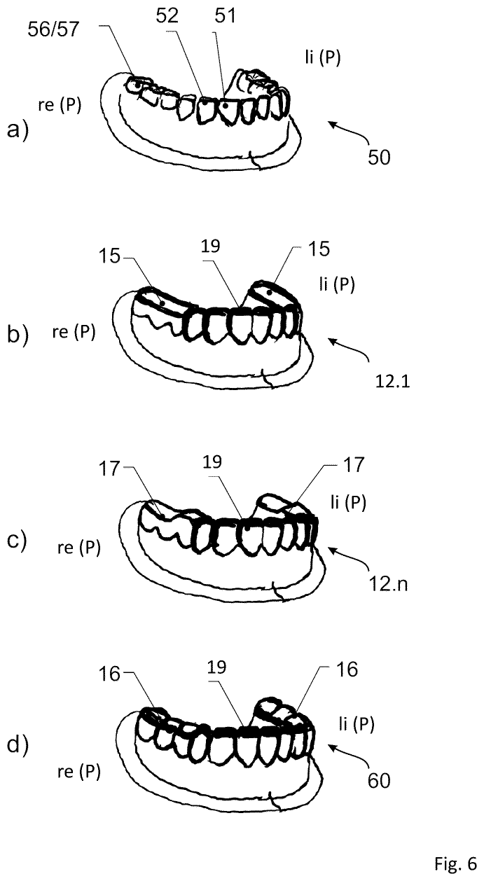

FIG. 6 the incremental transition with sliding function, ramp function and height function in the molar region and form function in the anterior region,

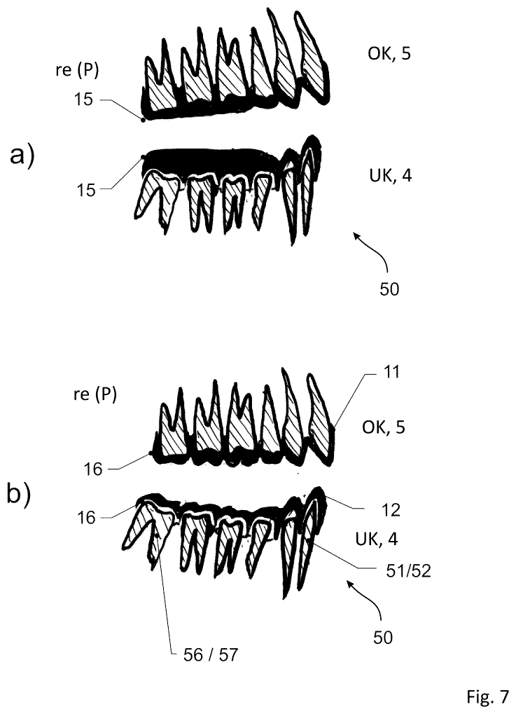

FIG. 7 the height function in an asymmetrical configuration, for example,

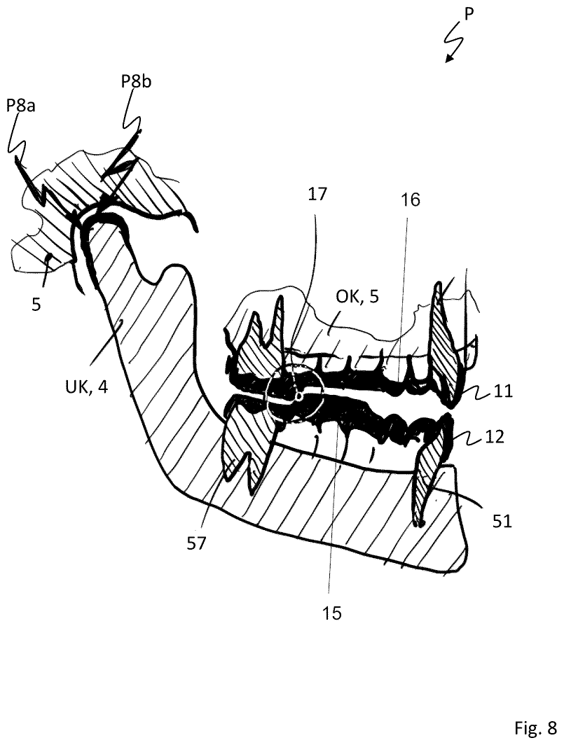

FIG. 8 a height function combined with a ramp function for craniomandibular dysfunction CMD,

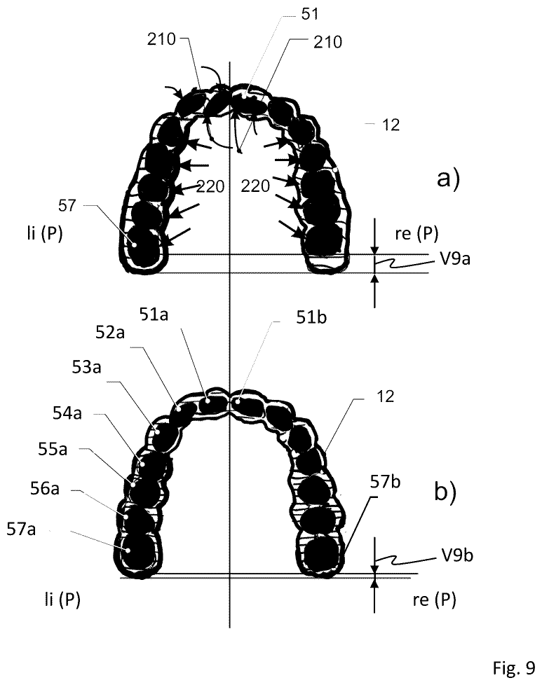

FIG. 9 an example of the hidden alignment function and move function,

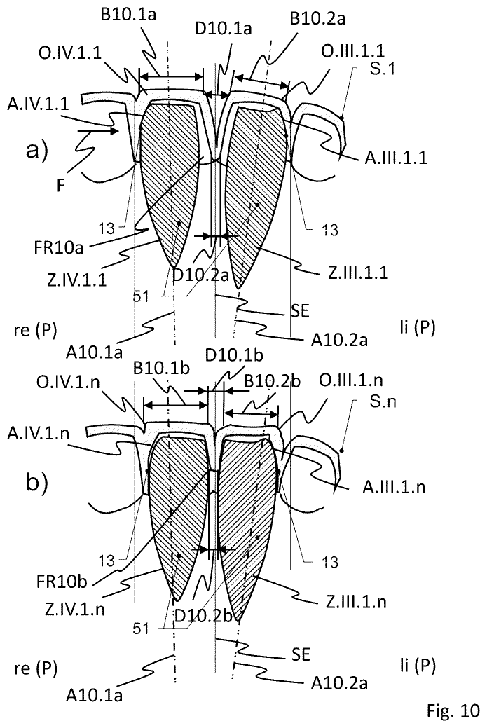

FIG. 10 for comparison, an alignment function on anterior teeth that may be observed through a transparent aligner splint using a shape function (tooth veneer(s)),

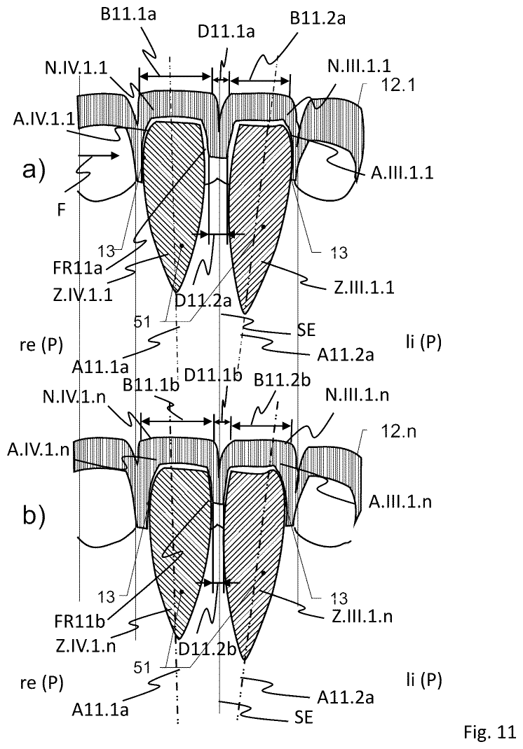

FIG. 11 in the sectional view, the concealed alignment function in the case of two anterior teeth that are set apart,

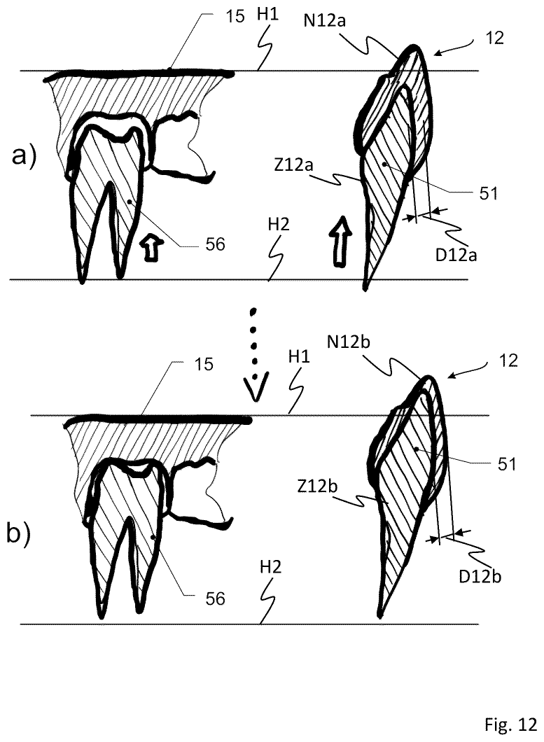

FIG. 12 the concealed distal outgrowth of natural teeth,

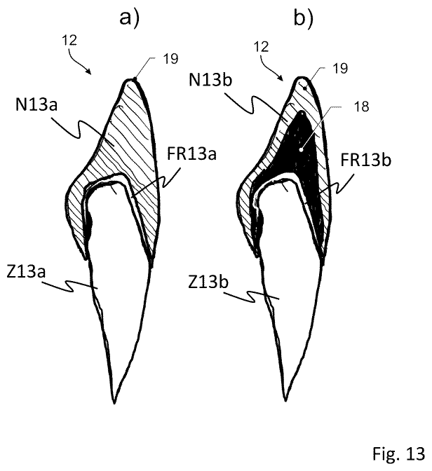

FIG. 13 a sectional view of a multi-layer structure of a lower jaw device,

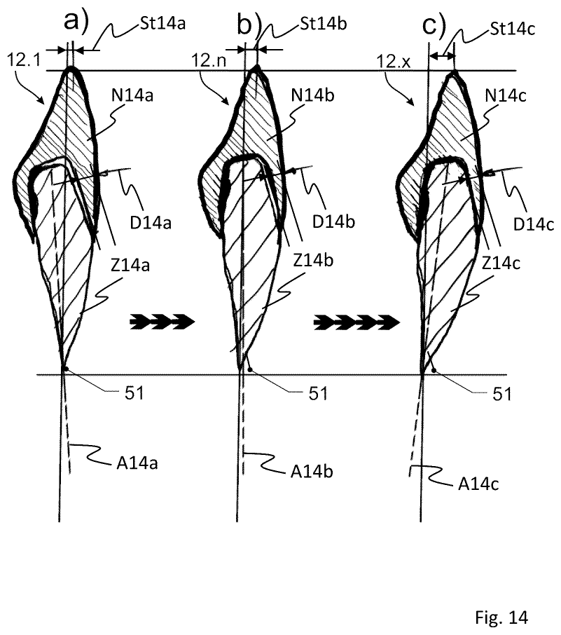

FIG. 14 the shifting function in combination with the shape function (tooth veneer(s)) in the sense of a shifting displacement of the visible tooth regions towards a larger dental arch in the sectional view,

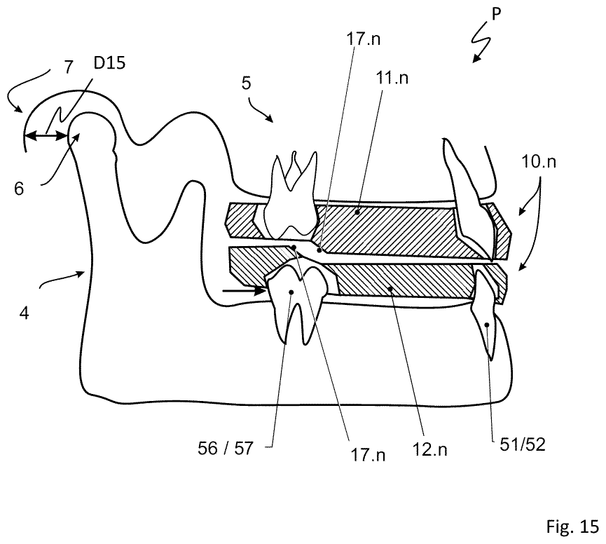

FIG. 15 a device with height function and ramp function and slide function and alignment function and shape function, and

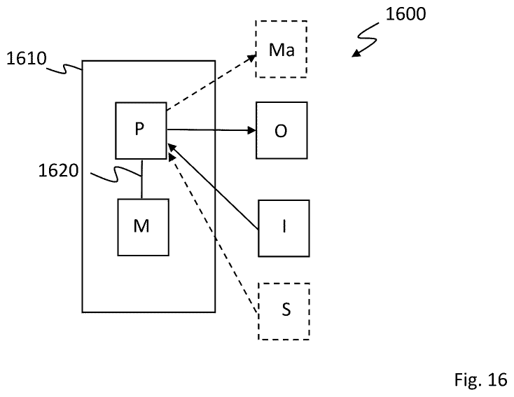

FIG. 16 a computer system.

Experts are faced with a multitude of requirements and objectives which, strictly speaking, should be achievable in combination. The above detailed description of the state of the art shows that practicable methods are known for each of these sub-areas and that equally practicable devices may be available. However, the devices and methods available to date may only fulfill a part of the requirements in each case. An integrated combination of elements and measures in a single device or in a progressively changing series of devices was not previously known or available, in particular not the synergistic effects resulting from this.

The proposed technology may represent a major expansion of the functional scope of the devices that may be used to optimize a dentition or the entire chewing/masticatory apparatus, which is very important for the success of treatment. In addition to the pure alignment functions 210, which are possibly supplemented by the classical orthodontic functions 220 such as traction/tensile devices, a selection of at least one, preferably at least 2, particularly preferably at least 3 further functions may be added as now proposed.

In particularly complex embodiments, 4 or 5 or 6 function types may be combined. The preferred additional functions may be selected from the following group, for example: Shape function 230, Color function 240, Height function 250, CMD function and Cranial function. A particularly preferred combination of function types is alignment function 210 AND shape function 230 AND height function 250 AND color function 240 AND CMD function.

From a biomechanical and orthopedic point of view, the effect of combined treatment may even extend beyond the chewing/masticatory apparatus. It may affect not only the teeth, the temporomandibular joint and the skull bone. It may also affect the atlas, the cervical spine and the rest of the musculoskeletal system, in particular the thoracic spine and the lumbar spine, e.g. down to the sacrum. The initial results with this type of combined treatment indicate that cranial optimization may also improve misalignments in the spine.

Described systematically and schematically, the polyfunctional integrated method may comprise treatment phases characterized by many different functions, in particular phases of a treatment plan.

Such a treatment plan may therefore not be represented for each of the teeth on only one level. An entire level of the treatment plan may be created for each functionality that optionally acts on a tooth, e.g. with the numbers of the teeth from left to right and with the numbers of the devices or device pairs or device stages from top to bottom. This would provide a “third dimension” to the treatment plan in addition to the number of the respective tooth and the number for the device or the respective pair of devices due to the number of functionalities. This would be too comprehensive for a description within the given framework. Therefore, the description focuses on the different types of functions or functionalities, i.e. on the several levels of the treatment plan, whereby the different types of functions may have a different effect on each tooth of the dentition.

In the general case, unlike comparative aligner splints, the proposed solution may comprise a multidisciplinary variety of functions that may be incorporated into a sequence of pairs of devices 10.n (n=1 . . . x), each with upper jaw splint (upper jaw device) 11.n and lower jaw splint (lower jaw device) 12.n. Three groups of functions are explained in more detail below. Further functions may be added. Likewise, some of the functions described may only be used if required, i.e. optionally.

### Displacement Functions Alignment 210 and Shifting 220

The classic orthodontic functions may be part of the selection of functions to be combined. The alignment function 210 concerns the displacement of at least one tooth relative to the dental arch and in particular relative to the neighboring teeth. Therefore, the alignment function 210 may also be represented if only the intraoral scans of the surfaces of the dental arches of the upper jaw OK, 5 and of the lower jaw UK, 4 are available. The possible forces and moments that may be exerted on teeth may optionally be changed by attaching so-called attachments to the teeth.

The shifting function 220 concerns the force-driven displacement of individual teeth by interaction with the opposite side by means of rubber bands or lateral wedges, etc. A combination of the alignment functions 210 with shifting functions 220 is also part of the possible proposed new combinations in a polyfunctional method and in the polyfunctional devices 10.
1) Function type alignment function 210 (alignment function): At least one pair of devices 10.n comprises aligner elements, in particular aligner cavities or material recesses for receiving and guiding the force of the teeth. These may interact directly with selected teeth or with attachments that are attached to selected teeth.
2) Function type shifting function 220 (Shift): At least one pair of devices 10.n comprises additional functional force-exerting elements. These preferably act between the upper jaw and lower jaw. They may be in the form of guide wedges or traction rubbers, etc.

### Functions Shape 230 and Color 240

Two particularly striking new functions should be emphasized. One or two functions are integrated which may have both technical effects and may also influence the aesthetics: the shape function 230 of the new shape of the teeth and the color function 240. The shape function 230 may be made possible by the fact that the shape of the tooth veneers, which together form a device, does not in principle follow the predetermined shape of the teeth of the person P in the actual state. Rather, the shape of each tooth veneer may already be optimized or restored in a device 10, in particular by replicating at least one target tooth arrangement. In the case of dentitions with abraded teeth, for example, this may be useful in order to achieve the appropriate height of the chewing surfaces later on.

The second function is the color function 240, which may include not only the actual color of the tooth veneers, but also the complex color effect of the teeth. Each tooth veneer may have its own color function and basically this color distribution could change from device n to device n+1 in the series 100.
3) Function type shape function 230 (shape): At least one pair of devices 10.n may comprise artificially shaped tooth veneers or artificially shaped tooth portions, here called tooth veneers or also tooth bodies, in particular replicas of at least one target tooth arrangement. The upper jaw splint 11 and/or the lower jaw splint 12 may comprise several specially shaped tooth veneers. The tooth veneers may conceal the receiving regions for the teeth or tooth stumps so that their relative movement takes place gradually in the background. Tooth veneers are also used to fill gaps and to provide implants with stable tooth veneers. If necessary, shape corrections, especially to the external geometry, may be carried out easily and cost-effectively at an early stage.
4) Function type Color function 240 (Color): At least one pair of devices 10.n comprises tooth veneers that are equipped with individual color properties. The scolor properties of the tooth veneers may differ from tooth to tooth, in particular the anterior teeth may have a different color than the canines and these may have a different color than the molars. The color function may be integrated at a very early stage of treatment in order to create an attractive appearance in combination with the shape function. The color appearance may be gradually approximated to a desired state in order to check the optimum appearance. In this way, color corrections may be carried out easily and cost-effectively at an early stage if required.

### Functions for the Molar Ranges 250/260/270

Unlike conventional aligner treatments, the proposed polyfunctional treatment may include a group of important functions that may be used in the molar region in particular, but which may have an effect on the entire chewing/masticatory apparatus. For example, three complementary functions may be distinguished. Firstly, increasing the chewing surfaces (height function 250) in the sense of building up a certain thickness on the chewing/occlusal surfaces of the molars. The premolars and canines may also be affected by the elevation. In the region of the front teeth, it may be more of a clearly visible lengthening and enlargement.

However, the height function 250 may already be of great biomechanical and physiological importance, i.e. the elevation of the molars by means of supports that are integrated into the splint-like devices 10 consisting of upper jaw part 11 and lower jaw part 12. The supports may have different thicknesses on the upper right, lower right, upper left and lower left, so that there is asymmetry. Both in the sagittal plane and in the frontal plane, a new optimized position of the chewing plane may be achieved by attaching superstructures of different heights in the molar regions. The different thicknesses or heights of the superstructures on the molars may not be able to be specifically produced by deep drawing (thermoforming). However, 3D printing and 3D milling etc. may be used as manufacturing methods.

This must be distinguished from the design of a sliding surface (sliding function 260) in place of natural cusps and fissures in the molar region. The upper and lower sliding surfaces may correspond to each other, i.e. have complementary shapes, for example. The top may be designed differently than the bottom, e.g. almost flat and smooth at the bottom and more cylindrically crowned at the top, with the cylindrical axis from right to left. The different design may allow different sliding and rolling movements of the lower jaw relative to the upper jaw. This is referred to as sliding function 260. The sliding function 260 may require at least concealment of the cusps and fissures of the underlying teeth. Sliding surfaces may also be provided on superstructures of any thickness. The sliding surfaces may be planar or spherical or cylindrical or hyperbolic, convex, concave or otherwise shaped.

This must be distinguished from the execution of transversal shifting functions (transversal function, ramp function 270), which may have an anterior-posterior (front-back) and right-left lateral effect in the transversal plane. In the simplest case, these may be ramps or slopes which, for example, make further displacement more difficult or prevent it from a certain range. For example, a ramp running in the same direction on the right and left may be used to push the lower jaw forward as soon as the mouth is closed. Changing the orientation of the ramp in space may have the opposite effect and the lower jaw may be pushed backwards. With a counter-rotating ramp on the right and left, the lower jaw may be rotated or pivoted rotatory relative to the upper jaw. With partial anterior-posterior ramps or slopes, the lower jaw may be shifted from right to left or vice versa. All of this may require superstructures of a certain minimum height in the molar region. However, the superstructures do not necessarily have to include ramps or slopes.
5) Function type height function 250 (Height): At least one pair of devices 10.n may have height superstructures in at least one molar region, which may cover at least the fissures (tooth pit, tooth cusps). The height superstructures may be of different heights in the four quadrants I to IV of the dentition and/or they may be inclined differently. Preferably, the superstructures may be raised in the range of 0.5 mm (millimeters) to 6 mm. It is particularly preferred that they are 1 mm to 4 mm raised. The elevation/raising may indicate the total layer thickness over an occlusal surface, e.g. in the center of an occlusal surface. The superstructures may have bump-like structures on the contact surfaces and/or ramps and/or slopes or smooth sliding surfaces, which do not necessarily have to be flat.
6) Function type sliding function 260 (Slide): The pairs of devices 10.n may comprise sliding surface elements, preferably with a low surface roughness, in at least one molar region. The orientation of the sliding surfaces may be parallel to the previous chewing plane or inclined to the previous chewing plane, in particular to set a new chewing plane as the sliding plane. The sliding surfaces in the four quadrants I to IV may be complementary or differently shaped at the top and bottom. The effect of the sliding surfaces may be that the contact force may be largely perpendicular to the sliding surfaces as long as, for example, no ramps or impact/abutment forces or blocking forces occur.
7) Function type transversal function or ramp function 270 (Ramp): At least one pair of devices 10.n may comprise transversally force-acting structures in at least one molar region, for example ramps or local slopes. The ramps may be oriented in such a way that when the mouth is closed, they cause reaction forces in the contact between the upper jaw device 11 and the lower jaw device 12 that are not orthogonal to the chewing plane. Depending on the orientation of ramps or slopes acting in the same direction, transverse forces may result backwards, forwards, to the left or to the right. A combination of differently acting ramps on the right and left may result in torsional moments around the predominantly vertical axis. A special case of integrated local slopes may be created by forming stylized chewing/occlusal surfaces with cusps that generate a clear preferred direction in correspondence with the upper jaw/lower jaw opposing side, so that a transversal force effect may occur. Within certain mechanical limits, a combination of sliding function 260 and transversal function 270 or ramp function 270 may be possible, for example in that in one embodiment sliding on a sliding surface of a sliding function 260 is possible almost unhindered up to a certain abutment/stop range and then a slope of a ramp function 270 begins, which makes further movement more difficult or almost prevents it. A height superstructure of a height function 250 may also be present in order to enable the sliding surface of the sliding function 260 and the ramp of the ramp function 270.

### Additional Anchoring Functions 280/290

In most cases, the upper jaw splint 11 and the lower jaw splint 12 of the devices or pairs of devices 10 of a series 100 may each be held by retainers in the upper or lower dental arch.
8) Function type implant function 280 (Implant): At least one pair of devices 10.n may have at least one element for attachment to implants, i.e., for example, in the case where the person already has such implants or where such implants are implanted as part of the treatment plan. For biomechanical and physiological reasons, however, most implants must not be overloaded in the implant-bone interface, as this may weaken the anchorage in the jaw, as this would disrupt the bony anchorage in particular. The anchoring of the upper jaw splints or the lower jaw splints may be carried out on implants as part of the proposed method, for example by integrating special implant elements or implant functions 280, which attach the devices to the jaw without transmitting interfering forces and moments, for example. In particular, forces that act axially in the direction of the implant shaft are permissible.
9) Function type support/carrier function 290 (Support/Carrier): At least one pair of devices 10.n may further comprise at least one element that is supported on bony body structures covered with soft tissue, in particular gums. The support on the gums may be advantageous if no teeth or implants are required for sufficient anchoring and if, for example, many teeth are to be moved out of the jawbone to higher positions. The support function 290 may be necessary, for example, if no implants are present and/or if molars are missing or if regions of molars are missing.

### Polyfunctional Design Examples

The devices 10 of a series 100 may comprise upper jaw splints and lower jaw splints, which may be equipped with a plurality of functions, for example selected from a polyfunctional group of functions. The polyfunctional group of functions may comprise the correspondingly designed functional elements in at least two, preferably in some or many of the devices of a series 100.

The devices may use at least two or at least three or at least four different functions from the function types mentioned below over the stages or phases of the polyfunctional treatment with the devices or device pairs 10 in a series 100, preferably at least 5 function types, particularly preferably at least 6 function types, wherein the alignment function 210 and the aesthetic shape function 230 may particularly preferably appear at least in a section in the course of the series:
1) Function type Alignment function 210 (Align),
2) Function type Shifting function 220 (Shift),
3) Function type Shape function 230 (Shape),
4) Function type Color function 240 (Color),
5) Function type Height function 250 (Height),
6) Function type Slide function 260 (Slide),
7) Function type Ramp function 270 (Ramp),
8) Function type Implant function 280 (Implant), and
9) Function type Support/Carrier function 290 (Support/Carrier).

While the aligner splints according to the prior art represent a combination of the functions 210 and 220, the proposed type of fully integrated multifunctional devices comprises a selection of the functions 210 to 290, in particular also the shaping function.

The most clearly visible object may be that the devices comprise not only the alignment function 210, but at least additionally the shape function 220 and preferably also the color function 240 as, for example, an aesthetically important function. Since the shape functions 230 may optically largely conceal the alignment function 210, the alignment may be performed in the background and thus almost invisibly to an observer of the person P wearing the devices in sequence. Further technical effects may be added.

### Polyfunctional Method

The proposed method may generate and/or use a series 100 of polyfunctional devices 10.1 to 10.x, e.g. according to a polyfunctional treatment plan BP. The polyfunctional “staging” may include not only the alignment of the individual teeth, but also the other dimensions of the polyfunctional additional functions for each tooth or tooth region. For ease of representation in a graphical plane, the following does not show the assignments to the individual teeth of the dentition, but rather embodiments of a polyfunctional fully integrated sequence of steps across these several polyfunctional dimensions 210 to 290 of the treatment.

### Polyfunctional Polydimensional Treatment Plan BP

Not every tooth needs to be moved during an aligner treatment. Furthermore, a tooth to be moved does not necessarily have to be moved through all stages of the treatment plan. The proposed polyfunctional treatment may result in a geometrically and biomechanically and physiologically feasible group of treatment plans BP, which may, however, be three-dimensional, whereby only two dimensions, i.e. the polyfunctional dimension together with a number of the respective device according to a sequence in which the devices are used, are shown and explained here. In the case of a tooth row representation, these treatment plans could be placed one behind the other on separate levels and would then indicate for each tooth whether and to what extent the relevant function is to be activated. Due to the complexity of the effect of the polyfunctional devices, the treatment plan may therefore be three-dimensional. With a combination of preferably 5 to 8 types of functions, there may be 5 to 8 characteristics in each stage as to how to proceed with each of the teeth or which characteristics the splint should have in order to achieve this goal. Since there are usually several possible ways to proceed, e.g. to introduce the shape functions 230 and the color functions 240 sooner or later, this variability may be used to decide on the fastest or the most cost-effective treatment plan BP. Other selection criteria may also be used, e.g. immediate use of the shape function 230 to allow the person P to immediately become accustomed to the target state or to test this target state. If there are unexpected deviations from or collisions with the treatment plan, e.g. due to an accident suffered by the person P that affects their dental region or due to a lack of compliance on the part of person P or the patient, the treatment plan BP may be adapted. Polyfunctionality may offer considerably more adjustment options than the previous aligner treatments, which seem to be narrow banded in comparison.

In a particularly preferred embodiment, at least the alignment function(s) 210, the shifting function 220 (Shift), the shape function 240 (Shape), the height function 250 (Height), the slide function 260 (Slide) and the ramp function 260 (Ramp)may be combined. Additional possible functions are the color function 240 and, if required, the implant function 280 and/or the support/carrier function 290 may also be added.

In the treatment plan BP, the alignment may be planned first, whereby the alignment function 210 may be combined with the shifting function 220 (Shift) in the dental arch in order to achieve, for example, an outward shifting of the teeth towards a wider dental arch, e.g. in the lower jaw UK, 4 and/or in the upper jaw OK, 5. The enlargement of the dental arch or dental arches may be advantageous, for example, to create space for suitable tooth displacements and/or for later tooth superstructures.

If collisions of the teeth at the top of the upper jaw with teeth at the bottom of the lower jaw become apparent in the step-by-step treatment plan BP, the height of the chewing/occlusal surfaces may be increased by superstructures of a height function 250. Preferably, the height function 250 may already be used at the beginning of the treatment plan BP, whereby the layer thickness of the height function elements may be gradually increased from device to device. The first device may have a comparatively large jump (increase) in the height function elements of the height function 250 compared to the original starting tooth arrangement, e.g. of more than 2 mm or even more than 3 mm.

At the same time, the sliding function 260 may preferably be activated, because otherwise, for example, a biomechanically and muscularly as well as neurophysiologically stressful condition could result, particularly in the temporomandibular joint. However, in order to then be able to achieve the desired correction of the position of the lower jaw UK, 4, the ramp function 270 or ramp functions 270 may preferably be integrated into the devices in subsequent stages or phases of the polyfunctional treatment plan BP. However, this may also be done earlier. If the patient or person P wears implants, for example, implant anchoring elements 280 may also be integrated from the beginning. If the person is missing teeth that are important for support, support/carrier functions 290 may be integrated into the devices or into a subset of the devices of the series 100 as required.

### Multilayer Devices

Due to the use of the shape function 230, there may be requirements for the material of the visible areas of the splints (devices). A very appealing and natural-looking material is particularly preferred, for example multilayer PMMA (poly (methyl methacrylate)) or another suitable material. However, this material may be regarded as a single layer of material, i.e. a homogeneous material, for the purposes of differentiating between multilayer materials or single-layer materials. However, an attractive-looking polymer material may not be perfectly suitable for manufacturing the entire splint or the entire device from it. There may be materials that are better suited to forming the recesses that are to accommodate the teeth and possibly displace them.

In a preferred embodiment, the lower jaw (mandibular) splint and/or the upper jaw (maxillary) splint may therefore be made of at least two layers of different materials. An outer visible layer may be made of a material that looks as attractive as possible or feels good in the mouth. This material may also be a material that may sufficiently withstand the chewing effects of chewing movements, e.g. chewing movements that may occur even when person P is not eating. An inner layer or an inner region may, for example, be provided with surface elements or may consist of a material that reinforces the adhesive force (see, for example, FIG. 14).

In another embodiment, the chewing surfaces may be made of a comparatively abrasion-resistant material, while the other regions of the splints are made of another less abrasion-resistant material. As a result, the splints (devices) may remain functional for longer and/or be more compatible with health.

The inner layer or the inner region (see FIG. 14, number 18) may be completely or partially covered by a visually appealing outer layer. The inner layer or the inner region of the splint may have a locally different thickness, depending on the relative position of the receiving regions for the teeth in relation to the attractively designed visible tooth veneer of the shape function 230.

In a preferred embodiment, only the inner layer 18 or the inner region with the receiving region for the teeth may change in the sense of the progressive splints of a series 100, at least for a group of at least 2 or of at least 3 or of at least 4 successive devices 10, while the outer layer with the tooth-veneer shapes 19 remains the same in the sense, for example to enable the person P to already feel the target tooth arrangement, to reduce the number of changeovers when changing the devices or to enable other technical effects.

In the proposed devices, in a particular embodiment, the inner layer 18 or the inner region of a upper jaw (maxillary) splint 11 and or lower jaw (mandibular) splint 12 may be manufactured separately and inserted into the outer layer of this splint (see FIG. 14). Insofar as the shape function 230 remains the same over several devices 10 and only the receiving regions for the teeth to be displaced have to be displaced, in a special embodiment the receiving regions for the teeth may be made from the second material and inserted into the splint with the tooth veneer shapes 19 made from bodies in order to form the entire splint for the lower jaw or upper jaw. This may make it possible to considerably reduce the overall cost of manufacturing the splints or devices, as only the inner parts need to be replaced but the tooth veneers and possibly also other outer regions of the device may be used several times with different inner parts.

### Completion of the Treatment

The last device 10.x of the series of x devices concludes the aligner treatment and has thus led to a new position of the real teeth. The biomechanics may now also be optimized as a result of the correction of the chewing/masticatory plane, e.g. optionally carried out at the same time in the initial phase, but of course only when the teeth in this target geometry have been on the one hand functionally technically and on the other hand also aesthetically adapted by restorative measures. The required installation space may now be available because, for example, the bite has been individually raised by elevating the chewing surface and/or because space has been created by enlarging the dental arch. The final dental restoration 300 following the splint treatment by the series 100 of devices 10.1 to 10.x may differ from the last splint in that the teeth are now individually brought into this target geometry, e.g. by means of so-called “table tops”, bridge superstructures, onlays, veneers, etc. The final geometric state of the restored teeth may be the same or very similar to the shape and arrangement of the teeth in the dentition already reproduced by the sequence of splints 10 and finally by the last splint 10.x.

### Functional Technical Effects

The following functional and technical effects may result:
The mechanical stability of the devices may be considerably greater due to the attachment of the elements to provide the additional functions compared to devices that only have the basic alignment function 210.
In particular, the height superstructures of the height function 250 may lead to an increase in mechanical stability in the regions under which molars are arranged or are to be arranged again, i.e. briefly in the molar region of the devices.
In particular, the at least one or more tooth veneers included in the shape function 230 may significantly increase the mechanical stability of the device in the anterior tooth region of the device or devices.
There may be an early mechanical influence of the devices on the sensitive area on the inside of the upper lip and/or on the inside of the lower lip, which may stimulate the muscles of the masticatory apparatus and trigger neuromuscular processes.

The biomechanical and/or cranial optimization of the position of the chewing plane may be an important biomechanical and health benefit. This may be beneficial due to a reduced load on the teeth and a physiologically better kind of loading of the temporomandibular joints. Neuromuscularly, the advantage may be that the soft tissue is better stretched due to the larger volumes of the dental veneers and superstructures. This may have positive effects on biomechanics, as well as other esthetic and psychological benefits.

The increased stability may be used to apply greater forces to the teeth. The increased stability may reduce the risk of breakage of the devices, e.g. when inserting the device into the mouth, when removing the device from the mouth of person P or when dropping it.

### Further Functional Effects

In addition to the numerous functional technical effects, there may also be other functional effects. An important advantage, which is highly appreciated by patients, may be that the patient or person P may obtain a feeling for the target tooth arrangement and/or an aesthetically very pleasing appearance of the dentition or the replica of the target arrangement of the dentition very quickly or early on, even if the alignment function 210 and the shift function 220 as part of the series 100 may still lead to further tooth displacements in the background.

In terms of customer satisfaction, the advantage may be that the patient or person P may already see what the result will look like visually from the outside and/or feel what the result will feel like during the treatment, which will take several months.

Psychological and/or psychosomatic advantages or effects may be caused in particular by the higher bite and the larger tooth veneers. Larger teeth in place of abraded teeth that have become too short may speak for more youth and more strength. Patients may feel rejuvenated and in most cases may also feel much more physically comfortable. This may significantly increase the patient's willingness to undergo treatment and may lead to the devices being worn very willingly and without interruption, which may be very important for the success of the treatment.

The other advantages may be clearly positive when treatment planning is carried out in an intelligent and multidisciplinary networked way (see FIGS. 3 and 4). Thanks to the combined multidisciplinary mode of action of the 100 series of devices, the treatment goal may be achieved functionally and restoratively without jeopardizing the biomechanical processes and the cranial alignment of the chewing/masticatory plane, as was previously the case with conventional methods and devices.

In detail, there may be the following biomechanical, muscular and neurophysiological advantages in the area of the cranium, i.e. the bony skull. The biomechanics of the skull and the neurophysiology of the cranial musculature may have the effect of favoring the position of the chewing/masticatory plane in the cranial optimum. The cranial optimum may be approximated as closely as possible. This may lead to displacements and relaxation in the region of the skull and especially the temporomandibular joints. These may have an effect on the anatomy over a period of months and may amount to more than one millimeter. Such magnitudes may be considered as significant in the field of dentistry, where patients may find inaccuracies of even 0.1 millimeters disturbing. It may be much better to carry out the cranial optimization of the chewing/masticatory plane during the aligner treatment, because otherwise, i.e. with a subsequent correction of the chewing/masticatory plane, much of the dentition would change again. Consequently, in the proposed series 100 of devices 10.1 . . . 10.x, the elements for cranial optimization may be integrated appropriately in at least some of the devices, preferably in the earlier upper jaw OK, 5 and lower jaw splints UK, 4. The elements for cranial optimization may be, for example, higher-positioned slide rail regions of the slide function 260 or higher-positioned ramps of the ramp function 270. Put simply, the optimization may concern the position and/or the orientation of the morphological jaw joint axis, even if the jaw joint is not, strictly speaking, a hinge joint.

The polyfunctional treatment plan BP may use a combination of height function 250 and/or sliding function 260 and/or ramp function 270 to set the optimized chewing/masticatory plane aligned to the cranial anatomy and geometry. In particular, unilateral abrasions following unfavorable tooth extractions in earlier years may have led to a significant tilting of the chewing/masticatory plane. In order to realign the chewing/masticatory plane, an individually coordinated scheme may be designed from functions 210 to 290 in order to carry out the appropriate cranial optimization as far as possible and sensible. The actual final phase of the alignment function(s) 210 and the shift function 220 may only be possible after the chewing/masticatory plane has been adjusted according to a cranial analysis. Together with the adjustment of the chewing/masticatory plane, a treatment of disturbances in the temporomandibular joint may take place. These dysfunctions may slowly disappear if the chewing plane is optimally adjusted. However, in order to achieve faster progress in the treatment of the temporomandibular joints, polyfunctional treatment may use a combination of height function 250 and sliding function 260. This allows the functional effects of orthoses to be fully integrated into the devices and the treatment plan.

Preceding or following treatment with orthoses may therefore no longer be necessary after polyfunctional treatment.

### Advantages and Effects of Polyfunctional Technology, e.g. With Reference to Aesthetic Aspects

Esthetic advantages may be achieved for the first time in combination with the technical effects, the other biomechanical effects and/or the physiological advantages mentioned above. From the patient's point of view, the dominant advantage may be that the esthetic condition of the dentition is reproduced very early on, in the best case right from the start, and thus greatly improved externally, and that no pain occurs in the temporomandibular joint area during and after treatment.

Alignment functions 210 and shift functions 220 may be planned in such a way that a predictable enlargement of the dental arch may be achieved and the optimized position of the teeth in this enlarged dental arch, especially towards the end of the treatment. Additionally or alternatively, independently designed tooth veneers of the shape function 230 may be integrated. As part of the device 10, the independently designed tooth veneers may already be larger in the first splints and follow or correspond to the desired larger dental arch.

The polyfunctional treatment plan may therefore shifts the replicas with beautiful reconstruction of optimized tooth shapes forward in time for the observer by using tooth veneers or tooth replicas. This may be a clear external characteristic of patients or people P who are treated polyfunctionally. In contrast, patients who are only treated with aligners in the conventional way do not initially show any improvement in the esthetics of their dentition.

For the first time, polyfunctional treatment may bring about a very rapid and very clear improvement from an esthetic and/or tactile point of view, in that even severely abraded teeth that have become too short may be provisionally reconstructed very quickly. The rather aged visual and tactile impression of the abraded dentition may be quickly transformed into an attractive and healthy impression of a more youthful dentition using the tooth replicas or tooth veneers.

Polyfunctional treatment may have even more advantages: With the optional combination with color function 240, the tooth veneers of the splints may be gradually improved esthetically at a reasonable cost. At the request of the patient or person P, the splints may be designed in such a way that the tooth veneers visible from the front anticipate the desired tooth color/shade. In the treatment plan BP, an optimized color/shade may therefore be introduced at an early stage. High-performance additive manufacturing techniques may bring further advantages here. However, very high-performance materials, for example polymer multilayer materials, may also be used. These materials may make mechanically very stable devices possible. In addition, they may also create a very good aesthetic visual or tactile impression if machining is used, for example. Color corrections may be carried out at an early stage in order to avoid additional costs and extra work in the final restoration.

### Variable Combination of Functions Via the Step/Stage Sequence of the Series

The proposed devices 10 may each consist of an upper jaw splint 11 and a lower jaw splint 12 and may be characterized in that they may have a comprehensive combination of different types of functions. In principle, the above-mentioned function types are available for selection. The functions of the above-mentioned functional types may be applied to a tooth or a tooth region as required and appropriate. However, not all and/or not all of the functions of the above-mentioned function types must be used at the same time. This means that functions may also be omitted depending on need and suitability. The polyfunctional treatment plan BP may decide which functions are activated for which teeth and when, and which are not. The polyfunctional treatment plan BP may now take into account up to eight or more functions, for example, and the treatment pattern may be correspondingly varied. It will therefore not always be possible to extract all the functions of the polyfunctional treatment plan BP from a single device.

FIG. 1 shows a roughly schematic and very simplified representation of a series 100 of devices 10, wherein the devices 10 each consist of an upper jaw splint (rail) 11 and a lower jaw splint 12. The series 100 of devices 10 comprises x devices 10.1 to 10.x, where x is a natural number, e.g. in the range from 10 to 50.

The devices of a series may comprise a combination of functions, in the embodiment shown here at least a) alignment function 210, b) shifting function 220 and c) shape function 230. The functions may occur together combined in one device, or successively in different phases of the series 100 in an individual number of devices, or in individual devices only.

The alignment function 210 may be shown in contact elements 13, which may be suitable or adapted to transmit forces and moments of force to the teeth or tooth stumps in order to better align the teeth next to each other. Optionally, the teeth may be provided with attachments for this purpose.

The shifting function 220 may be manifested in a device in that the devices are suitable or adapted to displace the teeth according to a large plan, preferably in the sense of a larger and wider dental arch.

The shape function 230 may be shown on a device 10 in that at least some tooth veneers have an independent shape that differs from the shape of the real teeth or tooth stumps that may be restored, for example:
by reconstructing the shape, and/or
in that the tooth veneer, which covers the actual tooth or the underlying tooth, is larger and/or more voluminous than the underlying tooth, and/or
in that the tooth veneer is longer, and/or
in that the tooth veneers have a more suitable shape than the tooth.

As shown in FIG. 1, the reproduction visible from the outside may arise from or consist of the shape of the visible toothed veneers. It may be characteristic of the proposed technology that the shape of the device 10, insofar as it is visible from the outside, changes little or not at all over the devices of the series 100 or over some of the devices, while the changes are made in the concealed area and in particular on the concealed teeth.

Experts may recognize the differences between the devices 10 in the course of a series by the faintly visible attachment points of aligner elements 13 when the devices are outside the mouth of the person P. However, the changes to the person's dentition take place either in the region covered by the dental veneer(s) on the actual teeth of the dentition or in the molar region, which cannot be seen directly from the outside.

The treatment plan may generally comprise x stages, where x is the natural number mentioned above. The series 100 may comprise a number of x devices, one each for upper jaw OK, 5 and lower jaw UK, 4, i.e. a pair. The points of application for interaction forces between devices and teeth may change from device to device. As a result, teeth may be displaced step by step. The concealed force-functional elements 13 are systematically indicated in FIG. 1.

It may be of particular importance that the devices 10 are already optimized in shape and optionally also in color in the integrated technology. From the external geometry and/or color, for example, no difference may be seen between the devices 10 of the series 100 at a cursory glance. The differences between the successive devices 10 may lie in particular in the front teeth concealed by the tooth veneer(s), in particular in the exact position of the recesses in which the teeth engage, i.e. for example in the functional elements 13 that may exert forces on the teeth and in the free spaces that are given to the teeth for a reaction movement to these forces F.

The movement of the teeth may take place in the background following the treatment plan BP and may not be immediately visible from the outside. The last device 10 concludes the polyfunctional aligner treatment. The dentition with the teeth and tooth stumps in the new position may then be fitted with a final dental restoration 300. The tactile and visual impression may change only slightly during the transition from the last device to a final restoration. With the final restoration 300, the teeth may be blocked as little as possible, as otherwise the bony integration could suffer.

The devices or pairs of devices 10 of the series 100 may be worn one after the other by a person P (see, for example, FIGS. 8 and 10). All or some of the pairs of devices may include tooth/dental veneers. The tooth veneers are labeled N.I.1.2, N.II.1.2, N.III.1.2, N.IV.1.2, N.I.1.2, etc. according to their position. The designation here follows the designation of tooth positions as used by dentists and orthodontists, i.e. four quadrants or sectors I, II, III and IV are used and the teeth in a quadrant are numbered from 1 to n from front to back in relation to the reference system of the person P. Seen from the observer, quadrant I may be at the top left, quadrant Il at the top right, quadrant III at the bottom right and quadrant IV at the bottom left. This means that the order of the quadrants may be clockwise or to the right. The following may apply to the designation of the tooth veneers:
the first letter is an N (replica, tooth veneer) as opposed to a Z for teeth or an A for recesses,
the Roman numeral in the second position indicates the quadrant, as indicated above,
the number in the third position indicates the position within the quadrant, and
the number in the fourth position indicates the number of the device concerned in the sequence of devices 10 in the 100 series.

For example, the tooth veneers N.I.1.2, N.II.1.2, N.III.1.2, N.IV.1.2 are located in this order in the first quadrant I, in the second quadrant II, in the third quadrant III and in the fourth quadrant IV in the first or front position respectively. As shown in FIG. 1, the aforementioned veneer positions are located in the second device, which is indicated by the last digit in each case. Corresponding tooth positions of corresponding anterior teeth behind the tooth veneers in the inserted state of the device 10.2 are Z.I.1.2, Z.II.1.2, Z.III.1.2 and Z.IV.1.1. The second tooth at the top left as seen from the observer has the designation Z.I.2.2, i.e. it is located in quadrant I at the second position in the device 10.2. Thus, the corresponding tooth veneer or tooth replica is designated N.I.2.2.

The number n may refer to a device or to a pair of devices 10 in the middle part of the sequence or series 100, see, for example, tooth veneer N.I.2.n, which is located at the same position as tooth veneer N.I.1.2 and whose outer surfaces, in particular its front surfaces, may be designed like tooth veneer N.I.1.2. Three points indicate that between a third pair of devices 10.3 and the pair of devices 10.n there may be at least one further pair of devices of the series 100 in the sequence, typically several pairs of devices.

The number x may refer to the last device or the last pair of devices 10.x in the sequence or series, see for example tooth veneer N.I.1.x, which may correspond to the tooth veneers N.I.1.2, N.I.1.n, i.e. may have the same external shape and/or be arranged at the same position in relation to the upper tooth arch of the devices, in particular the upper jaw devices 11. Three dots again indicate that between the pair of devices 10.n and the pair of devices 10.x there may be at least one further pair of devices of the series 100 in the sequence, typically several pairs of devices.

Device parts that are located in the device on the right “right” as seen from the observer (dentist, technician, orthodontist) are located on the left with respect to the person (P) carrying the device (the pair of devices), which is indicated by “li (P)” in the figures. Similarly, parts of the device that are located in the device on the left “li” as seen from the viewer are located on the right with respect to the person (P) carrying the device (the pair of devices 10.1, etc.), which is shown as “re (P)” in the figures.

FIG. 1 thus clearly shows that the front region of the devices 10.1 to 10.x may remain unchanged while the alignment functions 210 of the devices change. In addition or alternatively, the front region of the devices 10.1 to 10.x may remain unchanged while superstructures in the molar region change, e.g. superstructures with height function 250 and/or with sliding function 260 and/or with ramp function 270, see for example the molar regions in the first quadrant I, which may be different in the first device 10.1 than in the second device 10.2 and which may be different in the last device 10.x than in the middle device 10.n, see arrows P1 and P2.

FIG. 2 shows a roughly schematic functional representation of a comparative aligner treatment plan BP2 for a number of x aligner splints S.1 to S.x. The functions comprised therein may be divided into alignment function 210 and shift function 220. Alignment function 210 is used, for example, to improve the integration of individual teeth or groups of teeth into an existing dental arch. The shifting function 220 is used, for example, for large-scale displacement or modification of the tooth/dental arch, e.g. in the sense of widening the tooth arch to create more space. In many cases, such a widening may be carried out with shift functions 220 in order to be able to carry out an alignment of existing teeth in the first place, i.e. to create the space required for this. Since aligner splints may also press against the teeth from the inside and consequently tilt them outwards, there may be a certain overlap between alignment function 210 and shift function 220. So-called attachments may often correspond to the alignment elements on the recesses in the splints that hold the teeth, but these are not attached to the splint but to the respective tooth. The space for the tooth in the aligner may often allow a certain amount of movement in the desired direction of tooth displacement. Therefore, alignment functions 210 in combination with shifting functions 220 alone may be successful up to certain limits. The sequence of splints may guide the teeth into a new constellation, whereby in particular those teeth may be shifted and/or rotated that originally deviated strongly from the target state. After aligner treatment with the last aligner 10.x, the teeth are in a new formation, but still look the same as before. Only now may the teeth be further restored with esthetic and dental technologies in a final treatment 300, e.g. with veneers and/or crowns and/or table tops. In this case, the appearance of the teeth may change only now, but now abruptly. This type of aligner treatment may have considerable weaknesses and only a very limited effect, especially in adult patients or people with abraded teeth and misalignments.

In the comparative example, the treatment plan BP2 may include only two partial treatment plans BP2a, BP2b, which illustrates the use of only a few function within a comparative series S1-x of devices or pairs of devices. In particular, the comparison series S1-x may not include a shape function 230, i.e. no tooth veneers. On the contrary, the devices or pairs of devices S1, . . . , S.n, . . . S.x of the comparative series S1-x may be designed with a transparent or at least translucent material.

FIG. 3 schematically shows a proposed polyfunctional treatment plan BP3. The series 100 comprises a number of x devices 10. The series 100 is based on the initial state 200 of the dentition. The first device of the series 100 is the device 10.1, the last device is the device 10.x. In the series 100 of polyfunctional treatment steps, the state 10.x is reached with device 10.x, i.e. the end of treatment with splints or devices. A final treatment 300 may then take place.

This polyfunctional combination of the functional elements, which are realized in a fully integrated combination in a series 100 of devices 10, produces the multidisciplinary effect that is not possible with simple aligner splints, e.g. with the comparative aligner splints S.1 to S.x according to FIG. 2. Starting from the state achieved with the devices 10, the final restorations 300 with table tops, veneers, etc., may then be carried out, i.e. only after the last splint 10.x has been removed.

If the color function 240 is activated, the color selection may have already been tested in advance during the polyfunctional treatment. In the embodiment shown, the alignment function 210 with displacement of the teeth relative to their neighbors may extend over a large part of the series 100 or, as shown, over the entire series 100. The devices 10.1 to 10.x then carry suitable alignment elements or a suitable position or shape of the recesses for the teeth throughout at selected recesses in order to displace selected teeth by contact forces and rotational or tilting moments in combination with the required freedom of movement.

In the embodiment shown, the polyfunctional variety may comprise the alignment function 210, the shifting function 220, the shape function 230, the color function 240, the height function 250, the sliding function 260, the ramp function 270 as well as the implant function 280 and the support/carrier function 290.

The arrows along the function columns show that a function may be optionally activated, but does not have to be continuously activated on all devices. In general (not shown here), some of the functions in the present series 100 may not be activated at all, for example because a patient (person P) does not need this function. The implant function 280 may be activated particularly rarely, namely only if implants are present.

It is clearly visible that the shape function 230 may be used right from the start, i.e. already in the first device 10.1 and/or in all devices 10.1 to 10.x, e.g. using tooth veneers or tooth replicas. This may be comparatively unproblematic in some treatment cases. In other cases, this may be supported or enabled by other suitable functions of functions 210, 220, 240 to 290.

The use of the dental veneers may have a technical relationship to the color function 240 in that transparent materials without coloring and/or without white or other non-transparent coatings may not be suitable for providing the visual veneer function. However, transparent materials may be used, for example, if the stabilization function and/or the tactile function of the dental veneer are sufficient or offer sufficient other advantages.

The color function 240 may optionally also be used right from the start, i.e. in the first device 10.1 and/or in all devices 10.1 to 10.x. The color function 240 may optionally be changed within the series in order to find a suitable color tone or suitable color gradations. The color function 240 may implement a color that is different from transparent and/or translucent material. In the context of this understanding, the color white is also considered a color here, as it may also perform a cover or veneer function.

For example, the arrow in the shifting function 220, which starts later, indicates that an alignment is first carried out before the shifting function 220 is started at device 10.f.

The initially activated sliding function 260 means, for example, that the first devices in the molars may support sliding devices, while the later ones no longer do. The height function 250 (Height) in the molar regions, on the other hand, is present throughout the example because, for example, the teeth were abraded and the bite that was previously too deep needs to be corrected. In general, the functional elements realized in the devices 10 may differ between successive devices. Device 10.n therefore not only looks different from the subsequent device 10.n+1 in terms of the geometry of the force-transmitting elements 13, it may also comprise a different combination of functional elements and functional types, although the exterior of the tooth veneers may remain the same or unchanged.

An important feature may be that the shape function 230 as a mechanical stabilization function, possibly also as a function with, for example, a biomechanical effect or as an aesthetic function, may also start very early, while no tooth veneers are used in the comparative aligner treatments according to FIG. 2, and thus the shape and/or the position of recesses behind or in the tooth veneers is also not changed relative to a tooth veneer that is unchanged towards the front. The change in shape is suggested by the design of the tooth veneers, which together belong to the device 10, i.e. not by simple material reshaping around receptacles or recesses for receiving the teeth.

In the compressed polyfunctional representation of the treatment plan BP3 selected here, it should be noted that each of the columns for each of the functions may refer to the pattern of the generally maximum 32 teeth of the dentition. The view shown is therefore a sum of the teeth of the dentition.

Activation of a function means that it is activated for at least one tooth or at least one group of teeth in the device in question. In addition to the multifunctional “staging” shown here in FIGS. 3 and 4, a complete multifunctional treatment plan BP3 or BP4 also includes the tooth/dental “staging” in relation to the individual up to 32 tooth positions. However, this distribution of activation to individual teeth is not shown here.

The treatment plan BP3 may be completed with a final restoration 300, i.e. e.g. by veneers and/or crowns or table tops, preferably oriented to the final or target tooth condition, i.e. in accordance with the labial shape of the tooth veneers N,I.1.1, etc., which is also oriented to the final or target tooth condition.

Treatment plan BP3, for example, comprises nine sub-treatment plans BP3a to BP3i, which correspond in this order to the functions 210 to 290 mentioned above.

FIG. 4 shows a treatment plan BP4 for a special, but also frequently occurring case without implant function 280 and without support/carrier function 290, but with pronounced shape functions 230, i.e., for example, shape function of the anterior visible tooth veneers of the splint, and/or color functions 240, i.e., for example, color design of the anterior visible tooth veneers of the splint, in particular deviating from transparent and/or translucent.

In this case, the upper jaw splints 11 sit directly on the teeth of the upper jaw OK, 5 and the lower jaw splints 12 sit on the teeth of the lower jaw UK, 4. The step-by-step alignment function 210 with displacement and alignment of teeth ends in a position that is then available for the final restoration 300. At the same time, depending on requirements in the case shown, a phase of the shift function 220 takes place in the middle area of the sequence, in which the teeth are moved outwards, for example. This shift function 220 may be much more pronounced in other cases. It may often be the prerequisite for having sufficient space to be able to shape and size the teeth individually after the polyfunctional treatment by series 100 in the final phase 300 (final restoration).

The step-by-step updating/tracking of the alignment function 210 is illustrated by several arrows to show the increased complexity of the alignment compared to FIG. 3. For example, the alignment may affect different teeth in the course of treatment plan BP4.

The shape functions 230 may also be graduated, as indicated by several arrows, e.g. in order not to move too abruptly from the initial state to a final state, i.e. that, for example, an enlargement of the dental arch is not carried out immediately and thus obviously visible to all, but in stages and thus more inconspicuously for third parties and possibly also for the person P. This means that the shape function 230 (veneering) does not have to be based on the final target tooth condition from the outset. Intermediate target tooth states may be used. Alternatively, a constant or only slightly changing shape function 230 may also be used in treatment plan BP4 using associated tooth veneers and/or tooth replicas.

Further functions may optionally be added, e.g. an orthosis function 275, e.g. an orthosis according to Saxler, see WO2020141134A1, which is hereby incorporated by reference for all legal purposes. The separation slip plane of the orthosis may be determined according to Saxler (3D structure marking/marker/ruler) or according to another method. The orthosis may or may not comprise an edge gap.

In FIG. 4, the optional color function 240 is shown activated in stages with a sequence of arrows in order to move from the initial state not too abruptly to an optimized brighter state, e.g. from a more yellowish coloring to a more whitish or white coloring. Alternatively, a constant or essentially constant color function 240 may also be used in treatment plan BP4, e.g. the color may only change within the scope of the manufacturing possibilities and/or manufacturing tolerances.

Here in FIG. 4, as in FIG. 3, the height function 250 is continuously active because the teeth were abraded in the initial state 200. The sequence of arrows along the function column 250 indicates that successively different heights of the superstructures are used in the molar regions.

The sliding function 260 is shown in phases on the devices or on the pairs of devices 10.1 to 10.x, for example by sliding regions in the molar region.

The ramp function 270 is additionally activated in phases, especially if the biomechanics of the temporomandibular joint make this necessary, e.g. in the second half of the 100 series.

The sequence shown here is intended purely as an explanatory aid. The correct sequence for a given patient or person P may be determined on the basis of the initial condition and with the help of the planned target condition. In any case, polyfunctional treatment offers many times more treatment options, even for complex misalignments and wear and tear conditions, than was previously possible. The target group may range from 30 to 80 years of age, i.e. it may be very large. The willingness to invest may be high because the functional advantages, particularly in terms of aesthetics and/or tactile aspects, are perceived as decisive. Particularly in the case of patients aged 50 and over, and especially in the case of persons aged 60 and over, a pure aligner therapy which, for example, only uses aligner functions 210 and possibly also shifting functions 220, may not usually make sense due to wear and tear.

Treatment plan BP4 comprises sub-treatment plans BP4a to BP4i, which correspond in this order to functions 210 to 290 above.

In the method explained with reference to FIG. 4, further optional functions may also be added, e.g. an orthosis function 275, e.g. an orthosis according to Saxler, see WO2020141134A1, which is hereby incorporated by reference for all legal purposes. The separation slip plane of the orthosis may be determined according to Saxler (3D structure marking/marker/ruler) or according to another method. The orthosis may or may not comprise an edge gap.

FIG. 5 shows in the upper picture a lower jaw part 12 as part of a device or a pair of devices 10. FIG. 5a shows a first device part 12 from a first phase of the series 100 and FIG. 5b shows a second device part 12 from a second phase or a second partial section of the series 100.

FIG. 5a shows a sliding surface 15 in the molar region with the number 15. This may be a feature of an activated height function 250 in combination with an activated sliding function 260.

In FIG. 5b, the height function 250 is still activated but the sliding function 260 is deactivated. Instead, the ramp function 270 is activated in the form of small but effective slopes on the teeth in the molar region. This may be seen in the hump-shaped contact surface 16 with sloping flanks and small ramps, see arrow P5. These shifts the lower jaw UK, 4 transversely forwards during contact bite, i.e. they have a completely different effect than the sliding function 260 at the same bite height.

In both FIG. 5a and FIG. 5b, the anterior teeth are covered and concealed by tooth veneers 19, which belong to the lower jaw splint 12. The displacement of the actual teeth is thus concealed. In the anterior region, the aesthetically designed tooth veneers 19 form a cover. The alignment functions 210 and the shift functions 220 are installed underneath in the recesses for the teeth, according to individual and phased requirements. However, this may only be seen when the splints are removed from the mouth. The superstructures 15 and 16 cover the teeth in the molar region. However, these may only be seen from the outside when the mouth is wide open, for example.

FIG. 6 shows schematically different states of devices 10, which are taken as an example from a series 100, in each case only the lower jaw splint 12. The upper jaw splint is omitted in each case for better representation of the molar regions.

FIG. 6a shows the initial state 50 of the teeth of personP or the patient. FIG. 6a shows an anomaly in the dental arch, which often occurs as a result of classic orthodontic measures, for example after extraction of two teeth in the lower jaw. The dental arch in the lower jaw, which was too small, had not been widened, for example. This promoted abrasion of the teeth. The condition of the temporomandibular joint is now often suboptimal and craniomandibular dysfunction CMD may often be present. The temporomandibular joint and the chewing plane may then also require treatment.

According to FIG. 6b, the first mandibular splint 12.1 sits on the dentition in the initial state 50, but it already shows the shape function 230 on the large tooth veneers 19, behind and/or under which the anterior teeth are located. In contrast to FIG. 6a, the anterior teeth thus appear at first glance to be no longer in need of treatment, even if they are in need of treatment and even if they are currently being treated.

Starting from the splint 12.1 in the initial state 50, there may be a phase in the polyfunctional treatment plan BP and an associated number of devices in which raised sliding surfaces 15 are provided on the right and or left in the molar region 56/57. The sliding surfaces may be predominantly flat or part of a hypersurface. They may thus build up a sliding function 260. The extent of the elevation results in the heights for the height function 250. The contact surfaces in the molar region may also comprise ramps of a ramp function 270 and steps or different slopes.

According to the vectorial force decomposition, the contact at ramps and/or slopes may cause a force component of the chewing/masticatory muscles to act on the lower jaw UK, 4 in such a way that a lateral or anterior-posterior force component is produced. As a result, changes in the contact forces in the jaw joint may be achieved and the lower jaw UK, 4 may be displaced or twisted/rotated relative to the upper jaw OK, 5.

In a particular embodiment, an asymmetrical arrangement of sliding surfaces 15 and ramps 17 in the molar regions on the right and left may be selected in such a way that complex position corrections are possible, composed of translation and rotation in, for example, a total of 6 degrees of freedom, see in particular FIG. 6c.

An intermediate or final goal of the polyfunctional treatment may be the state 60 shown in FIG. 6d with a wider dental arch and larger tooth veneers 19. At the same time, for example, the chewing plane may be biomechanically correctly adjusted, particularly in the molar region, and malpositions in the temporomandibular joint may be corrected. All these different treatment objectives may be combined in a series 100 of devices 10, whereby the series of devices 10 each consist of an upper jaw splint 11 and a lower jaw splint 12.

FIG. 7 shows roughly schematically that a comparatively high superstructure 15 as in FIG. 7a may be used, particularly in the molar region, firstly to achieve a release of the lateral mobility of the lower jaw and/or secondly to form a sliding surface with functional type 260 (slide). The superstructure 15 may also be referred to as a thickening. The superstructure 15 may be completely filled with material in its interior, i.e. it is solid. Alternatively, the superstructure 15 may also comprise cavities in its interior, in particular if mechanical stability is ensured. Cavities may reduce the weight of the device.

The lateral mobility of the teeth in the contact state may be necessary in order to be able to move the teeth better and/or without collision by means of the alignment function 210 (alignment function) and/or by means of the shifting function 220. If, on the other hand, the chewing/occlusal surfaces were coated with a layer of comparatively homogeneous thickness, as in the comparative aligners shown in FIG. 2, neither a sliding surface would be formed nor would mobility be released.

FIG. 7b shows a special variant that initially uses thinner superstructures if high superstructures introduced very quickly, as shown in FIG. 7a, for example, would lead to discomfort. The height of the superstructures required for treatment may therefore be gradually increased from the state shown in FIG. 7b to the state shown in FIG. 7a as required. The condition shown in FIG. 7b may already lead to a certain amount of relief for the jaw (temporomandibular) joints.

The direction in which the lower jaw is displaced may be set, for example, by the slopes in the detailed design of the contact surfaces 16 between the upper jaw OK, 5 and the lower jaw UK, 4. In the meantime, alignment functions 210 and shifting functions 220 may already be possible and used within a narrower framework.

In the case shown in FIG. 7a, it may be necessary to make the superstructures in the upper jaw OK, 5 on the side shown less pronounced than in the lower jaw UK, 4. This may be useful, for example, if the chewing/masticatory plane is unphysiologically inclined and/or is to be shifted according to a cranial or cranial analysis of the cranial symmetry conditions in the skull of patient P. Such complex shapes of the devices for the upper jaw OK, 5 and lower jaw UK, 4 cannot be produced by deep drawing, for example. However, they may be produced using additive manufacturing, e.g. 3D printing, or subtractive manufacturing, e.g. milling.

The superstructures 15 may be symmetrical or asymmetrical to each other on the left and right.

FIG. 8 clearly and schematically shows a section through the jaw of a patient P wearing a device consisting of two parts 11 and 12, which may be characterized by special features. The device may comprise or include a bite ramp 17 in the molar region and a sliding surface 15 also in the molar region. When the lower jaw UK, 4 and its sliding surface 15 move backwards along an anterior-posterior (front-back) axis, contact occurs at the bite ramp 17 in the dotted circle. This impedes the posterior movement of the lower jaw UK, 4 and thus prevents the posterior compression of the temporomandibular joint 5, see arrow P8a.

The height of the bite ramp 17 and the sliding surfaces 15 is adjusted, for example, in such a way that upward compression of the temporomandibular joint 5 is also prevented, see arrow P8b. This allows the muscles to stretch and the temporomandibular joint apparatus to relax. If the sliding surfaces 15 are of different heights and the position and type of the ramps 17 on the right and left are asymmetrical, this may cause a shift in the chewing plane as long as the device is worn.

Since it is planned to apply a final restoration 300 after the last device 10, this optimized position of the chewing/masticatory plane is prepared with the aid of the polyfunctional treatment and the device from the series 100 in such a way that this physiologically favorable position may subsequently be realized with the final restoration 300.

If the use of conventional aligner devices, i.e. aligner devices without height extensions, meant that it would not be possible to perform the superstructures and correction functions 250, 260, 270, he/she would be forced to perform the complex final restoration 300 in the old non-physiological position of the chewing/masticatory plane. Or the patient would now be burdened with an abruptly changed chewing/masticatory plane. The gradual change of the chewing/masticatory plane and/or the cranial optimization with the aid of superstructures, on the other hand, enable a successful treatment that was previously not possible or only possible with a considerably longer treatment time.

FIG. 8 shows in detail a schematic diagram of a typical case that may occur, for example, after the extraction of four premolars as a late consequence of orthodontic treatment. The misalignment may lead to severe abrasion and even loss of the normal arrangement of the teeth in the sense of a Spee's curve. In such a case, the teeth must not only be displaced by tilting moments, but also elongated, i.e. moved upwards or downwards, for example, so that the section protruding from the gums is “extended”. This may be achieved, for example, by corresponding relief areas for the teeth in the upper jaw with clearance to the, for example, solidly constructed upper jaw splint (not shown, see FIG. 12 for the lower jaw device 12).

FIG. 9 shows the transverse section through a lower jaw device 12 for the lower jaw UK, 4 in two successive situations as shown in FIG. 9a and FIG. 9b. In FIG. 9a, the incisors 51 in particular are twisted and not optimally positioned. While the outer contours of the device 12 remain largely the same, the teeth 51a, 52a, 53a, etc. on the left side of the lower tooth/dental arch of the person P and the teeth 51b, 52b, 53b, etc. on the right side of the lower dental arch of the person P are moved concealed by the dental veneers of the device inside or behind the dental veneers by the alignment function 210. In the process, the free space in which a tooth may be positioned gradually shifts from device to device relative to the externally visible tooth veneers.

This makes it possible for the final shape or final appearance of the dentition to be reproduced very quickly or at a very early stage when viewed from the outside, while the alignment may continue to progress hidden by the veneering regions of the device. The molars in FIG. 9a are too close together, particularly on the right, and are too far forward, see offset V9a. This may be due, for example, to the fact that a molar on the lower left was extracted at a young age and a wisdom tooth on the left subsequently closed the tooth gap, while the wisdom tooth on the lower right was extracted.

FIG. 9b shows the situation after successful displacement of the anterior teeth by alignment functions 210 in combination with a successful large-scale displacement of the molars by shifting functions 220, which widen the tooth/dental arch. In addition, a reduction of the right-left offset of the proximal molars 57a and 57b may take place, i.e. an offset V9b is considerably smaller than the offset V9a, for example smaller than half of the offset V9a or even smaller than a quarter of the offset V9a.

As may be clearly seen from the hatched contour of the splint in the sectional view, the shape of the tooth veneers of the splints 12 visible from the outside, especially from the front, does not change significantly. The displacement of the teeth may typically be concealed. The height functions 250 and/or sliding functions 260 and/or ramp functions 270 that may be required at the same time are not shown or cannot be shown in the sectional view.

FIG. 10 shows a comparative example of an aligner splint, e.g. made of thermoformed, predominantly transparent thermoplastic film material. The frontal section through the incisors of the lower jaw is shown with a splint sitting on it. FIG. 10a shows an initial state S.1 with incisors 51 that are too far apart, i.e. more precisely a right anterior tooth Z.IV.1.1 seen from the person P and a left anterior tooth Z.III.1.1 seen from the person P, the last digit here indicating the position of the respective tooth, for example at the time when the device with the same number is first placed on the teeth. It may be seen how the predominantly transparent coating follows the contours of the teeth, whereby a small space for movement is provided in each case for the intended displacement of the incisors 51 shown towards the center, see e.g. free space FR10a. A force-transmitting contact region 13 is provided on the pressure side in each case. The force-transmitting element 13 may be an active surface that acts directly on the tooth 51 or that acts indirectly on the tooth 51 via an attachment (not shown) on the tooth 51. A resulting force vector F points from left to right in FIG. 10a to indicate the direction of the left-right displacement of the tooth 51, Z.IV.1.1.

FIG. 10b shows the state Z.n of the same teeth Z.IV.1.n, Z.III.1.n after advanced displacement towards the mid-sagittal plane SE. The gap between the incisors 51 or anterior teeth closes. The predominantly transparent splint envelops the teeth step by step and also follows the migrating incisors 51 shown here. Characteristic of this comparative aligner technology is the largely identical layer thickness of the thermoforming film that partially envelops the teeth and/or the comparatively conforming reproduction of the shape of the recesses on the outer shape of the devices.

FIG. 10a also shows an occlusal region O.IV.1.1 above the tooth Z.IV.1.1 and an occlusal region O.III.1.1 above the tooth Z.III.1.1. The occlusal region O.IV.1.1 forms the upper ceiling of a recess A.IV.1.1 for the tooth Z.IV.1.1. The occlusal region O.III.1.1, on the other hand, forms the ceiling of a recess A.III.1.1 for the tooth Z.III.1.1.

FIG. 10b also shows an occlusal region O.IV.1.n above tooth Z.IV.1.n, which is identical to tooth Z.IV.1.1 but has a different position and/or inclination, and an occlusal region O.III.1.n above tooth Z.III.1.n, which is identical to tooth Z.III.1.1 but has a different position and/or inclination.

In FIG. 10a, an axis A10.1a shows the original position of the tooth Z.IV.1.1. An axis A10.2a shows the original position of the tooth Z.III.1.1. The occlusal region O.IV.1.1 has, for example, a maximum width B10.1a. The occlusal region O.IV.1.1 has, for example, a maximum width B10.2a. Labial outer surfaces or lingually directed surfaces of the device on the walls of the recesses A.IV.1.1 or A.III.1.1 may also have similar maximum widths. A distance D10.1a (distance) lies, for example, between the occlusal areas O.IV.1.1 and O.III.1.1. A distance D10.2a lies between the recesses A.IV.1.1 and A. III.1.1.

The axes A10.1a and A10.2a are also shown in FIG. 10b to illustrate the change in the position of the teeth 51. Tooth Z.IV.1.n is shifted to the right from the viewer's perspective compared to the position of the same tooth Z.IV.1.1 in FIG. 10a. Tooth Z.III.1.n, on the other hand, is shifted to the left from the viewer's perspective compared to the position of the same tooth Z.III.1.1 in FIG. 10a.

The occlusal region O.IV.1.n, for example, has a maximum width B10.1b, which is approximately equal to the width B.10.1a. The occlusal region O.III.1.n, for example, has a maximum width B10.2b, which is approximately equal to the width B.10.2a. Labial surfaces or lingually directed surfaces of the device in the area of the recesses A.IV.1.n or A.III.1.n may also have similar maximum widths. The widths B10.1b and B10.2b may be unchanged because the device S.n has also been manufactured using the deep-drawing process and the width of the teeth 51 has not changed and therefore neither have the tooth replicas in the shape used for deep-drawing.

A distance D10.1b (distance) lies, for example, between the occlusal regions O.IV.1.n and O.III.1.n. The distance D10.1b is smaller than the distance D10.1a, which is due to the thermoforming process, which now depicts the smaller distance between the teeth 51. The same may also apply to the distance between labial surfaces on the walls of the recesses A.IV.1.n and A.III.1.n.

A distance D10.2b (distance) between the recesses A.IV.1.n and A.III.1.n may be the same size as the distance D10.2a, again due to the deep-drawing process. A free space FR10b in the recess A.IV.1.n is much smaller than the corresponding free space FR10a in the recess A.IV.1.1. It should be noted here that the deep-drawing process is carried out around a model (deep-drawing mold) of the teeth 51, whereby the model (deep-drawing mold) has been extended by areas in which the free spaces FR10a, FR10b etc. will later be located.

FIG. 11 shows an embodiment with the differences to the comparative example (see FIG. 10), especially in the anterior tooth region. The lower jaw (mandibular) splints 12.1 and 12.n are made of a polymer, for example, or comprise a polymer that preferably has an aesthetically high-quality appearance similar to tooth substance and tooth enamel, i.e. is also glossy, for example, but preferably not transparent. The anterior teeth 51, which are still too far apart in FIG. 11a, should be moved so that they are closer together, but only to the extent that the distance is not required for the larger tooth veneers or for the restoration of the anterior teeth in the final completion phase or in the final restoration phase 300. The tooth veneers are already formed early during the treatment by the splint(s) 12.

In FIG. 11a, the bodies (tooth veneers, tooth replicas) of the incisors or anterior teeth 51 are already significantly larger than the partially abraded teeth 51. This is achieved by the fact that the bodies or tooth veneers of the teeth 51 extend further beyond the incisors than the areas of the splint S.1 or S.n in the comparative example according to FIG. 10. The incisors 51 are largely or completely covered by the tooth veneers in the visible area.

The splint 12.1 shows force-transmitting contact regions 13 between or at the recesses in the splint and the teeth 51. As a result, the teeth 51 are displaced in such a way that they are increasingly closer together, see for example the force vector F. Viewed in detail, the recesses for the teeth to be displaced move relative to the predominantly unchanged tooth veneers that form the splint 12.1 or are comprised in the splint 12.1. During this gradual migration of the recesses for the teeth, the wall thickness of the splint changes in the direct vicinity of the teeth to be displaced, see distance D11.2a versus distance D11.2b. The freedom of movement in the direction of the progressive displacement is created anew each time and the contact area 13 is readjusted each time in order to be able to apply force moment/torques to the teeth again with the subsequent splint.

FIG. 11b shows the displaced teeth 51 at a smaller distance. Here, the tooth veneers, e.g. N.IV.1.n and N.III.1.n, are larger than the teeth 51 or Z.IV.1.n and Z.III.1.n, in particular larger than the regions of these teeth 51 not located in the gums. However, the tooth veneers or tooth replicas, e.g. N.IV.1.n and N.III.1.n, preferably look like teeth.

The spacing of the teeth 51 may preferably be somewhat larger compared to FIG. 10b, because more space will or may be required for the larger tooth veneers. It may be characteristic of the proposed embodiment that tooth veneers which are larger than the teeth form a frontal section of the splint and that, concealed within the splint, the recesses which receive or accommodate the teeth and supply them with contact forces move stepwise relative to these tooth veneers in the direction in which the tooth is to be displaced, so that the tooth follows the displacement relative to the tooth veneers of the splint. Furthermore, it may be characteristic that the tooth veneers may be significantly longer in relation to the comparative example in FIG. 10, for example in order to restore the original length for abraded teeth or to restore a length that extends beyond this. Neither of these features occur in the comparative aligner splints.

Thus, a free space FR11a may be much narrower than a free space FR10a, e.g. because a different manufacturing technology is used, e.g. subtractive or additive manufacturing technology versus thermoforming (pressure, vacuum and/or temperature).

A resulting force vector F points from left to right in FIG. 11a to indicate the direction of the left-right displacement of tooth 51, Z.IV.1.1.

FIG. 11a also shows an occlusal regions of a dental veneer N.IV.1.1 above the tooth Z.IV.1.1 and an occlusal regions of a dental veneer N.III.1.1 above the tooth Z.III.1.1. The occlusal region of the tooth veneer N.IV.1.1 forms the upper cover of a recess A.IV.1.1 for the tooth Z.IV.1.1. The occlusal region of the tooth veneer N.III.1.1, on the other hand, forms the cover of a recess A.III.1.1 for the tooth Z.III.1.1.

FIG. 11b also shows an occlusal region of a dental veneer N.IV.1.n above tooth Z.IV.1.n, which is identical to tooth Z.IV.1.1 but has a different position and/or inclination, and an occlusal region of a dental veneer N.III.1.n above tooth Z.III.1.n, which is identical to tooth Z.III.1.1 but has a different position and/or inclination.

In FIG. 11a, an axis A11.1a shows the original position of the tooth Z.IV.1.1. An axis A11.2a shows the original position of the tooth Z.III.1.1. The occlusal region of the tooth veneer N.IV.1.1 has, for example, a maximum width B11.1a. The occlusal region of the tooth veneer N.IV.1.1 has, for example, a maximum width B11.2a. Labial outer surfaces or lingually directed surfaces of the device on the walls of the recesses A.IV.1.1 or A.III.1.1 may also have similar maximum widths. A distance D11.1a (distance) lies, for example, between the occlusal areas of the tooth veneers N.IV.1.1 and N.III.1.1. A distance D11.2a lies between the recesses A.IV.1.1 and A.III.1.1.

The axes A11.1a and A11.2a are also shown in FIG. 11b to illustrate the change in the position of the teeth 51. Tooth Z.IV.1.n is shifted to the right from the viewer's perspective compared to the position of the same tooth Z.IV.1.1 in FIG. 11a. Tooth Z.III.1.n, on the other hand, is shifted to the left from the viewer's perspective compared to the position of the same tooth Z.III.1.1 in FIG. 11a.

The occlusal region of the tooth veneer N.IV.1.n has, for example, a maximum width B11.1b, which is approximately equal to the width B.11.1a. The occlusal region of the tooth veneer N.III.1.n has, for example, a maximum width B11.2b, which is approximately equal to the width B.11.2a. Labial surfaces or lingually directed surfaces of the device 12.n in the area of the recesses A.IV.1.n or A.III.1.n may also have similar maximum widths. The widths B11.1b and B11.2b may be unchanged because the tooth veneers already have the target shape or an enlarged shape.

A distance D11.1b (distance) lies, for example, between the occlusal regions of the tooth veneers N.IV.1.n and N.III.1.n. The distance D11.1b is the same size as the distance D11.1a, because the tooth veneers or tooth replicas N.IV.1.1, N.III.1.1, N.IV.1.n and N.III.1.n already have their target shape and are no longer changed in the anterior region and/or in the occlusal region and/or in the lingual region. The same may therefore also apply to the distance between labial surfaces and/or lingual surfaces on the walls of the recesses A.IV.1.1, A.III.1.1, A.IV.1.n and A.III.1.n.

A distance D11.2b (distance) between the recesses A.IV.1.n and A.III.1.n may be smaller than the distance D11.2a, as already mentioned above, e.g. due to a more precise manufacturing process that is not a deep-drawing process. A free space FR11b in the recess A.IV.1.n may be smaller than the corresponding free space FR11a in the recess A.IV.1.1 or the same size.

The devices 12.1 and 12.n shown in FIG. 11, and preferably also all other devices of the same series 100, may have been produced by subtractive manufacturing processes, e.g. milling, or by additive printing processes, e.g. 3D printing, which, compared to deep-drawing processes, allows in particular the production of greater variations in the layer thickness of occlusal surfaces and/or allows undercuts to be produced, e.g. with respect to an up-down direction of the teeth of the person P.

FIG. 12 shows cross-sectional images through molars and anterior teeth in two different successive stages of treatment with the proposed splints, using the mandible mandibular 4 as an example.

FIG. 12a shows a splint with a high superstructure (e.g. with sliding surface 15) in the molar region of a lower jaw (UK not shown), which encloses a molar 56 that is too low. This molar should move upwards. In

FIG. 12a, there is an unfilled cavity above the molar in the recess into which the molar may migrate. In the area of the anterior tooth 51, outgrowth is also possible if the forces are applied accordingly.

According to this, FIG. 12b shows a later state still with sliding surface 15, in which the molar tooth 56 has grown into the recess in the splint 12. The anterior tooth 51, which has also grown out, may require the splint 12 to have a deeper recess into which the tooth 51, which is now further up and therefore larger above the gum, fits. It may be characteristic that in FIG. 12 the teeth are displaced without the outer contours of the device 10 or the lower jaw (mandibular) splint 12 shown here changing. The different required wall thicknesses of the splint 12 or the device 10 are realized by suitable manufacturing processes, e.g. by precise machining of polymer materials or by 3D printing. FIG. 12 does not show that the position of the teeth may also shift sideways during treatment and that the axis of the teeth may be tilted, e.g. simultaneously with the lifting out or as an alternative thereto.

The same tooth Z12a, Z12b is shifted upwards in FIG. 12b compared to FIG. 12a, see horizontal lines H1, H2. The outer contour of the devices 12 may remain unchanged, see tooth veneer N12a, N12b in the front area of the devices 12 and/or also the position of the sliding surface 15 in relation to the lines H1 in the back tooth area of the devices 12.

In this way, a distance D12a or D12b corresponding to the layer thickness of the tooth/dental veneer N12a or N12b in the front region may be reduced, whereby the position of the tooth veneers N12a or N12b with respect to the horizontal lines H1, H2 is unchanged and/or the outer shape/contour of the tooth veneers N12a or N12b does not change or changes only insignificantly, in particular in the front region.

FIG. 13 illustrates two variants of a structure of tooth veneers 19, N13a, N13b in the anterior tooth region that look the same when viewed from the outside. FIG. 13a shows a structure made of a solid material, whereby the outer contour is made of the material of the visible tooth veneers N13a, while the inner contour of the material forms the receiving region for the tooth Z13a. The inner surfaces of the recess may exert forces and moments locally on the tooth Z13a as a stimulus for movement.

FIG. 13b shows an arrangement that looks the same from the outside. Here, however, the device consists of two materials in two areas when viewed locally. The sectional view of FIG. 13b shows the tooth veneer 19, N13b in the outer region, preferably made of aesthetically pleasing material, in particular non-transparent material. The region 19, N13b consisting of this material has a larger recess on the inside than the tooth Z13b requires. This larger recess is partially filled by a second material so that a suitable recess remains for the tooth Z13b. This inner filling 18 may be softer or harder than the shell of the tooth veneer 19. In a particular embodiment, the outer tooth veneer areas remain the same over several successive devices 10.n, 10.n+1 etc. and only the shape of the recesses for the teeth in the filling region 18 of the device changes. In each case, a section through a lower jaw device 12 is shown, but the same variants may apply to the upper jaw device 11.

A narrow free space F13a may lie between the tooth Z13a and the bottom of the tooth veneer 19, N13a, which may also be referred to as a tooth replica. Similarly, a narrow free space F13b may be located between the tooth Z13b and the bottom of the tooth veneer 18, 19, N13b, in particular the bottom of the inner material of the tooth veneer 18, 19, N13b. The tooth veneer N13b may also be referred to as a tooth replica because, together with the tooth Z13b, it replicates the target tooth condition of this tooth Z13b.

FIG. 14 shows three selected steps in the series 100 of the devices or pairs of devices 10, in particular the lower jaw devices 12.1, 12.n and 12.x, specifically an incisor tooth Z14a, Z14b and Z14c in section in three successive steps of a displacement, which may be proposed to be referred to as a shifting function 220. The purpose of this displacement may be, for example, to enlarge the tooth/dental arch by pushing the teeth further outwards. Since the teeth are firmly seated with roots in the jawbone, the displacement referred to as shift can, in detail, be a tilting of the tooth about a low-lying tilt axis with accompanying adjustment of the tooth arch in its dimension (expansion) and/or alignment. With the proposed shifting function 220, the tooth is no longer merely tilted, but the tooth veneer is displaced and adjusted in size. The recess for the actual tooth 51 may be changed in the sense of tilting by applying the forces well above the tilting axis. With the splint in place, the replica N14a, N14b, N14c of the subsequently restored tooth 51 appears displaced, although the actual tooth 51 is tilted in the concealed area. The displacement of the replica N14a, N14b, N14c and a corresponding restoration such as the last replica N14c may be optically or functionally more suitable for teeth that are too far inwards than a purely directly visible tilting of the teeth outwards, unless the teeth were tilted too far inwards in the initial state.

The same tooth Z14a to Z14c is shown in three different positions in which tooth veneers N14a to N14c are used, the outer contour of which, in particular the frontal outer contour, may be unchanged or remain the same. Axes A14a to A14c illustrate the above-mentioned tilting about a tilting axis, which in FIG. 14 is perpendicular to the plane of the sheet.

A distance St14a to St14c from a center line of the tooth veneers (tooth replicas) N14a to N14b to a vertical reference line, which may lie, for example, in the tilting axis, increases continuously and corresponds to the respective expansion or forward displacement of the tooth veneers N14a to N14b.

Material layer thicknesses D14a, D14b, D14c show the layer thickness of the tooth veneers N14a, N14b and N14c in their front region. The layer thickness D14b is reduced compared to the layer thickness D14c, e.g. because the reduction in the layer thickness due to the tilting of the tooth Z14b is greater than the increase in the layer thickness due to the displacement of the tooth veneer N14b. The layer thickness D14c is the same as the layer thickness D14c, e.g. because the reduction in layer thickness due to the tilting of the tooth Z14c is equal to the increase in layer thickness due to the displacement of the tooth veneer N14c in relation to the vertical reference line.

FIG. 15 roughly schematically shows a special case in an intermediate phase with device 10.n consisting of upper jaw splint 11.n and lower jaw splint 12.n. Ramp-like functional elements 17.n develop a laterally and/or anterior-posteriorly directed force component as a ramp function 270 on contact between the lower jaw UK, 4 and upper jaw OK, 5. In the example shown, movement of the lower jaw UK, 4 too far forward in the sense of a malposition known as a Sunday bite is specifically prevented. The ramp 17.n in the device 10.n may be gradually positioned and oriented differently relative to the molars 56, 57 in order to carefully move the lower jaw UK, 4 backwards step by step into a new rest position. At the same time, a massive elevation with height function 250 and a pronounced sliding surface with sliding function 260 may be integrated. The high superstructures in the molar region may be so massive or so high that the lower jaw UK, 4 must remain below the actual resting floating position even in the contact bite. In the temporomandibular joint head 6 you may see that it is far enough away from the rear wall 7 of the temporomandibular joint in the upper jaw, see distance D15. This means that the backward displacement of the lower jaw through the ramp function 270 is a target-oriented measure. Only by shifting the lower jaw backwards in combination with the clear height function 250 with solid or hollow superstructures in the molar region may it be possible to deblock a severe crossbite, for example.

FIG. 15 shows a situation in the middle phase of a series 100 in which the lower incisors 51, 52 have already been moved behind the upper incisors. This is an example in which it may make sense to initially leave the teeth in the lower jaw UK, 4 small and only then rebuild them as part of the splint(s) using suitably large and suitably shaped tooth veneers once they have arrived in the correct position. In the shortest possible state, the anterior teeth 51/52 of the lower jaw UK, 4 may be shifted backwards more easily from the malocclusion under the upper incisors. In the upper jaw OK, 5, on the other hand, the treatment with the shape function 230 and optionally with the color function 240 is or may be applied from the very beginning. At the end of the polyfunctional treatment with x devices, the last device 10.x may also be removed according to treatment plan BP. It may then be planned to carry out a final restoration 300 of the teeth or tooth stumps with veneers, table tops, etc., whereby the position of the chewing/masticatory plane has now preferably been optimized cranially and the superstructure heights above the remaining teeth may be retained.

FIG. 16 shows a computer system 1600 that may perform the method steps mentioned in this document, in particular in an automated or semi-automated manner. The computer system 1600 may include:
a computer 1610,
an optional input device I, e.g. one or more buttons, an alphanumeric keyboard, a computer mouse, a trackball, a data receiver unit (e.g. for receiving data via the Internet or an intranet),
an optional output device O, e.g. a screen (e.g. a touch-sensitive screen), or a data transmission unit (e.g. for sending digital data via the Internet or an intranet).

The input device may be used, for example, to “move” digital representations of the person's teeth on the screen. Alternatively or cumulatively, calculation processes may be started to calculate the device pairs 10.

The 1610 computer may comprise:
one or more processors P configured to execute program instructions, e.g. program instructions of an operating system (Windows (may be a trademark), IOS (Input Output System) (may be a trademark), Linux (may be a trademark), etc.), in particular program instructions of a user program for executing the method steps mentioned in this document or a part thereof, and/or
a memory unit M designed to store program instructions and/or data, e.g. data generated during the execution of the program instructions. The memory unit M may comprise volatile memory (e.g. RAM (Random Access Memory, DRAM (Dynamic RAM), etc.) or non-volatile memory (SSD (Solid State Device, EPROM (Electrical Erasable Read Only Memory), etc.), and/or
at least one computer program or computer program product, e.g. a BIOS (Basic Input Output System), which may be a stand-alone program or part of an operating system OS (Operating System), and/or
an optional bus 1620 between the processor(s) P and the memory unit M or other units of the computer 1610 or the computer system 1600.

There may be other units that are known to the skilled person, e.g. power supply, Internet or intranet connection, e.g. based on the Internet Protocol IP, etc.

A manufacturing machine Ma, e.g. a CAM computer aided manufacturing machine or a CNC (computerized numerical control) milling machine or a 3D (3 dimensional) printer, may be coupled to the computer system 1600, e.g. locally or via a data transmission network. A scanning device S (scanner) may also be coupled to the computer system 1600, for example to scan the teeth of the person P or a dental model of the teeth of the person P, in particular electronically and/or in the optical domain.

Thanks to the mock-up function (tooth veneer), the final position may already be visible or realized in the front when the first aligner is worn, e.g. with a 10 percent magnification. The magnification may be a value in the range of 1 percent to 20 percent, in particular in the range of 5 to 15 percent. This allows the wearing comfort of the lips, i.e. the balance between the soft tissues and the final position of the teeth, to be integrated right from the start.

Differently designed slopes between the two aligners allow treatment to be oriented towards centric (condyles and fossa in maximum ideal position) right from the start. The teeth may move inside the splints (devices). Due to the external design and the resulting keying, a centric condylar path may be achieved which is coordinated using CBCT/DVT (digital volume tomography) or another imaging method. From a medical point of view, this may be an enormous advantage of dental veneer aligners. They work against CMD and the associated posture and jaw problems right from the start.

For example, progenic dentitions, e.g. crossbite, often have a decentered dislocation of the condyles. In the course of treatment, an anterior tooth in the upper jaw, for example, must be moved forward. During this transfer phase, the tooth to be transferred must overcome the obstacle of the lower anterior tooth and ultimately balances on it, in front of it or behind it in the acute phase. This jiggling effect may be very damaging for the affected teeth and the temporomandibular joint may often slip too far backwards during this time (dorsocranial load vector), e.g. into the sensitive bilaminar zone, i.e. the zone that serves to stabilize the articular disc on the condyles and which is an essential factor for the metabolism of the temporomandibular joint. The bilaminar zone comprises, for example, the stratum superius and the stratum inferius. There it may sometimes cause considerable discomfort and even pain. Unfortunately, the frontal bites may only be frontal and may then cause an enormous lever effect on the temporomandibular joint when the muscles are tense. This in turn may lead to compression with temporomandibular joint problems. All of this may be prevented or significantly mitigated with embodiments and further developments of the new concept.

The well-known V.T.O. (Visual Treatment Objective) according to Ricketts (Holdaway) and model analyses (e.g. Staub-Cranial) are currently used in orthodontics to plan the therapeutic aids (dental devices) for the upcoming orthodontic treatment. The teeth are moved visually (virtually) in the upper jaw and lower jaw. However, a 3-dimensional repositioning of the teeth and jaws cannot be realized using this method, as parameters for determining the sagittal (only cephalometric analysis, lateral cephalometric analysis), coronal and horizontal determination of position cannot be included because, for example, only 2D lateral cephalometric radiographs are available.

When planning the “polyfunctional dental device”, these missing but useful parameters (determinants) may be determined as landmarks (structural markers), e.g. from 3D Dicom data (Digital Imaging and Communications in Medicine), which comprise digital image data (CT (computed tomography), CBCT (cone beam computed tomography), MRT (magnetic resonance tomography), . . . ) which may be used to analyze the jaw relation and tooth status. One possible analysis method is the cranial analysis according to “CranioPlan”, i.e. the “Saxler analysis”.

Dysgnathic force transmission into the lower jaw UK, 4 and/or into the upper jaw OK, 5 may be recognized and resolved orthognathically or eugnathically. This may be achieved by asymmetrical thickening, i.e. material thickening or elevation, for example, in the cranial direction (occlusal plane, tooth/dental arch left to right, right to left) of the “polyfunctional dental device”. Furthermore, a rotational moment/torque may result from the use of asymmetrical ramps in the device or a transversal displacement.

Determining the reference structure may comprise:
i) Determining of an inner ear axis, preferably using digital 3D image data,
ii) Determining the position of at least one eye,
iii) Determining at least one skull plane comprising the inner ear axis and the position of at least one eye,
iv) Using the cranial plane as an auxiliary plane or for the calculation of an auxiliary plane, e.g. by determining the mean value of two planes, each comprising one eye position,
v) Use the auxiliary plane to set the chewing plane:
A1) Determining an axis of rotation which is parallel to the inner ear axis and which lies on the other side of the inner ear axis compared to the eye axis,
A2) Using the rotation axis to rotate the auxiliary plane downward by a predetermined angle, e.g. by an angle in the range of 11 to 17 degrees or in the range of 13 to 15 degrees, so as to obtain the target chewing plane or a plane parallel to the target chewing plane, or
B1) Rotation of the auxiliary plane around the inner ear axis to obtain a second auxiliary plane, and
B2) Shifting (Translation) of the second auxiliary level downwards.
B2) to obtain the target chewing plane or a plane parallel to the target chewing plane,
B2) e.g. by a distance through which the displaced second auxiliary plane coincides with the target chewing plane obtained according to alternative A.

The exact angle may be determined, for example, with the help of a sphere that is digitally fitted into the digital data describing the foramen magnum, i.e. a large oval opening of the occipital bone of the skull, i.e. the back of the head.

The axis of rotation may be determined, for example, by:
Determine a first center point of the inner ear axis between the two inner ear points,
Determine a second center point of the eye axis between the two eye points,
Determine a distance between the first center point and the second center point,
Determine a straight line connecting the first center point and the second center point,
Extending the connecting line to the rear by a distance that has a length that is approximately the length of the determined distance increased by a factor of 2 in order to obtain the point through which the axis of rotation runs, e.g. a factor in the range from 1.5 to 2.5 or in the range from 1.75 to 2.25 or in the range from 1.9 to 2.1, i.e. the original length of the distance between the two centers is tripled, for example.

### Cranioplan

Deviating from planes, the so-called Spee curve of the occlusal surfaces of the teeth may still be determined and/or taken into account in the method referred to below as “CranioPlan”. In this case, for example, there are deviations in the position of teeth in the middle of the right jawbone (upper jaw or lower jaw) or in the middle of the left jawbone (upper jaw or lower jaw) where the respective teeth may be arranged below the chewing plane.

Method according to Hornung (EP 3 332 731 A1). This document is hereby incorporated by reference for all legal purposes.

Another method may use facial features, in particular facial features corresponding to said bony features of the facial skull, see e.g. US 2015/0265374 A1, which is hereby incorporated by reference for all legal purposes. This may reduce or minimize radiation exposure from X-rays.

The CranioPlan method may be performed manually, semi-automatically or automatically, in particular computer-assisted.

In another embodiment, the determining of the reference structure may comprise:
3D imaging and generation of digital data,
Manual identification or automatic identification of anatomical landmarks,
Definition of a transverse direction using the identified anatomical landmarks, which also defines the direction of a sagittal line,
Determine the center point between the anatomical landmarks,
Place the median sagittal plane Sm at the determined center point,
Use a digital 3D structure marker that comprises at least three layer packages:
1) A transveral plane package that comprises several transversal planes parallel to each other,
2) A frontal plane package comprising several frontal planes parallel to each other, and
3) At least one sagittal plane package comprising several sagittal planes parallel to each other,
Insertion of the 3D structure marker into the 3D image space,
Aligning the 3D structure marker with the medial sagittal plane Sm,
Translation of the 3D structure marker to a first anchor point, which is preferably located in the median sagittal plane.
Rotation of the 3D structure marker using a second anchor point.
Scaling of the 3D structure marking using a third anchor point,
Determining the ideal chewing plane using the 3D structure marking.

In the following, a preferred method is described for first determining the transverse direction using anatomical landmarks (part A) and then performing the further fitting steps (part B). The user may either place an axis such as 215 on an anatomical landmark such as zygomatic arches, orbits or inner ear regions in an image plane, or a plane that is perpendicular to the image plane, as this plane appears as a line in the sectional image.

### Part A:

1) 3D imaging: The first step may be to generate a 3D image of a body part, e.g. a patient's head.
2) Generation of digital data: By processing the images, a digital or virtual 3D body may be generated in a second step.
3) Visualization: In a third step, sectional images of this 3D body may be displayed.
4) Identification of anatomical landmarks: In a fourth step, landmarks of bony structures may be identified in appropriately selected sectional reproductions.
5) Definition of the transversal direction: In a fifth step, at least one transversal direction may be defined that connects, for example, two symmetrical landmarks. This may be done by an axis or by a plane and a second plane crossed to it.
6) Definition of the direction of the sagittal planes: In a sixth step, the position of the sagittal planes (Sm) may be defined, whose orthogonal normal is the transversal axis.
7) Determining the center point: In a seventh step, the center 211 between suitable landmarks may be determined to accurately define the median sagittal plane Sm of the upper cranium. This may not be completely unambiguous or offer certain degrees of freedom because the skull in the posterior region often has an orientation that is up to 2 degrees different from the anterior upper cranium.
8) Determining the position of the median (middle) sagittal plane Sm: In an eighth step, the median sagittal plane Sm may be determined by the center determined in the seventh step and the orthogonality resulting from the already determined transversal direction.
9) Check other views: In an optional ninth step or a number of such steps, other sectional views may be taken to check positions and directions or to complete other tasks and questions.

The order of the steps in part A may be changed as long as the result is that the orientation of the sagittal plane is defined using the anatomical landmarks.

The following 3D (three-dimensional) structure marker (marker or ruler for short) may be used for part B, which may comprise at least three level packages:
1) A set of planes comprising several transversal planes parallel to each other,
2) A plane package comprising several parallel frontal planes parallel to each other, and
3) At least one plane package comprising several sagittal planes parallel to each other, e.g. a left sagittal plane package and a right sagittal plane package.

The well-known Fibonacci sequence or Fibonacci series is: 3, 5, 8, 13, 21 etc., i.e. the next member of the series is the sum of the two previous members. This sequence may be used to define the distances between the respective planes in the three plane packages, for example by spacing the first two planes 3 mm apart, the second plane and the third plane 5 mm apart, the third plane and the fourth plane 8 mm apart, and so on.

### Part B:

1) Adding the 3D marker: In a first step, the 3D structure marker may be added to the 3D image space and faded in so that it may be seen in the display. The layer packages now appear as parallel lines.
2) Aligning the 3D marker to the medial sagittal plane Sm: In a second step, the structure marker may be aligned with its inner sagittal plane structure perpendicular to the transverse axis of the bony structures.
3) Translation of the 3D marker: In an independent third step 830, the 3D structural marker may be placed on an anchor point in the median sagittal plane, in an embodiment example, for example, with the crossing point of the lines or planes T3 (third transverse plane) and F5 (fifth frontal plane) in the median sagittal plane Sm on the basion point BP of the foramen magnum.
4) Rotation of the 3D marker: In a fourth step, the 3D structural marker may be oriented by rotation around an axis parallel to the transversal axis so that the transversal planes in the sagittal section run in the direction of a connecting line that follows, for example, the direction of the BP-GP axis (palatal point). In the embodiment example, the rotation may take place around a fixed point on which the intersection point T3 and F5 lies. The rotation brings the line T3 into such a position that it runs through the two anchor points, e.g. basion point BP and palatal point (GP). The 3D structure marking 500 is thus aligned at an angle.
5) Scaling the 3D marker: In a fifth step, the size of the 3D structure marker may be adjusted by linear scaling of the marker or the 3D structure marker so that a frontal line runs through a suitably selected anchor point 601. In the embodiment, the anchor point 601 is the nose point NP (nasion point). The individually correct scaling size is achieved in the embodiment example when the frontal line F1 and thus the frontal plane runs through the nose point or nasion point NP.
6) Analysis of symmetry: In a subsequent optional sixth step, the symmetry and harmony of the proportions in the body part may now be analyzed. This may often reveal tilting, e.g. of the jaw and the current chewing plane.
7) Determining the ideal chewing plane: In a further seventh step, the first transversal plane (T1) may be used as an idealized occlusal plane or idealized chewing plane, for example, in order to align dentures or devices accordingly. The first transversal plane 501.1 (T1) may run through the incisal point IP, i.e. the point of contact of the cutting edges of the two lower central incisors, which may be achieved in particular by using the Fibonacci sequence. In the case of separable devices with upper and lower parts, the parting plane between the two parts may particularly preferably be designed as a separating sliding plane, i.e. for example without retentions (protrusions) and with very low friction and/or roughness, e.g. less than 5 micrometers. The position of the separating sliding plane may be placed as precisely as possible on the position of the idealized occlusal plane in digital or virtual 3D space when planning and shaping the device, or also on a plane parallel to it if the idealized occlusal plane cannot be used or should not be used for medical or other reasons.

The sequence of steps in part B may be changed.

In a part C following the determination of the idealized chewing plane, regardless of the method used to determine the chewing plane, the following method may be used to manufacture a training device or a plurality of training devices in a series of devices:
In an eighth step following the seventh step of the method, the space for the teeth and/or dental implants of the upper and lower tooth/dental arches may be created so that the device later fits exactly on the individual dental arches without jamming or injuring the gums. Subtraction operations may be used for this. The edge gap may also be taken into account.
In an eighth step, the position of the device with its two parts in the mouth may be precisely defined by completing the digital shape in the eighth step with a planned form fit, e.g. only at certain contact/carrier points between the device and the dental arch.
In a subsequent ninth step, the device may be manufactured in its parts and for precisely this individual case and may then be used for this patient.

3D Marker or 3D Ruler according to Saxler and Hornung, see WO 2020/141134 A1. This document is hereby incorporated by reference for all legal purposes.

Another method may use facial features, in particular facial features corresponding to said bony features of the facial skull, see e.g. US 2015/0265374 A1, which is hereby incorporated by reference for all legal purposes. This may reduce or minimize radiation exposure from X-rays.

In other embodiments, the chewing plane may be determined using a different method compared to the method according to Hornung (EP 3 332 731 A1) or according to Saxler, Hornung (3D Ruler, WO 2020/141134 A1).

The 3D marker/ruler process may be carried out manually, semi-automatically or automatically, in particular computer-aided.

The determined chewing/masticatory plane may correspond with both methods (CranioPlan, 3D Marker/Ruler), but it does not have to. In both methods, three spatial angles of the normal of the chewing/plane to three coordinate axes of a Cartesian coordinate system and three position coordinates with respect to the three coordinate axes may be taken into account, i.e. a total of 6 parameters.

Deviating from planes, the so-called Spee curve of the occlusal surfaces of the teeth may still be determined and/or taken into account in the “3D Marker/Ruler” method mentioned above. In this case, for example, there are deviations in the position of teeth in the middle of the right jaw bone (upper jaw or lower jaw) or in the middle of the left jaw bone (upper jaw or lower jaw) where the respective teeth may be arranged below the chewing plane.

Alternatively, other suitable methods may be used to determine the target occlusal plane.

A series 100 of devices for incrementally changing the tooth position of a person P, comprising at least two devices 10, is explained,
wherein the devices 10 each comprise at least one jaw device 11, 12,
wherein the at least one jaw device 11, 12 is designed such that receiving regions of the jaw device 11, 12 may be placed on a dental arch of the upper jaw OK, 5 or the lower jaw UK, 4 of the person P,
wherein the devices 10 are designed such that, when worn according to a predetermined sequence of the devices 10, they provide an incrementally progressive change in tooth position by mechanical interaction of the device and at least one tooth element,
wherein the at least one jaw device 11, 12 of the first device 10.1, 10.2 carries on its outer side a first veneering element N.I.1.2, N.IV.1.2 as a partial area of the first device 10.1, 10.2,
wherein the at least one jaw device 11, 12 of the second device 10.n carries on its outer side a second veneering element N.I.1.n, N.IV.1.n as part of the second device 10,
wherein the first veneering element N.I.1.2, N.IV.1.2 is located at the same position according to a tooth scheme as the second veneering element N.I.1.n, N.IV.1.n,
wherein a receiving region of the first veneering element N.I.1.2, N.IV.1.2, is designed differently and/or has a different position than a receiving region of the second veneering element N.I.1.n, N.IV.1.n, this difference being suitable for effecting the incremental displacement of the tooth element, and
wherein a front-side wall thickness of the second veneering element N.I.1.n, N.IV.1.n differs from a front-side wall thickness of the first veneering element N.I.1.2, N.IV.1.2.

Furthermore, a method for designing polyfunctional dental devices is explained, comprising:
Capturing/Recording a starting tooth arrangement of a person P's teeth in their upper jaw and/or person P's teeth in their lower jaw, preferably together with at least one cranial and/or facial structure/feature in the skull region of person P,
Determining at least one reference structure of the person P before, during or after the recording, e.g. a cranial reference structure
Determining a target tooth arrangement of the teeth of the upper jaw OK, 5 of person P with respect to the reference structure,
Determining a target tooth arrangement of the teeth of the lower jaw UK, 4 of the person P with respect to the lower jaw UK, 4 or a target lower jaw UK, 4 of the person P including the reference structure,
Based on the starting tooth arrangement and the target tooth arrangement, or a target shape and/or target position of the target lower jaw, providing a data set series consisting of digital data set groups following one another in a sequence, e.g. data set pairs each with a data set for the teeth of the upper jaw OK, 5 and/or a data set for the teeth of the lower jaw UK, 4.

The target tooth arrangement may be used as the basis for manufacturing at least one tooth veneer, e.g. an anterior tooth veneer N.I.1.2, N.IV.1.2. The at least one anterior tooth veneer N.I.1.2, N.IV.1.2 may represent the tooth located at this tooth position in a target tooth state or in an enlargement of the target tooth state. The at least one anterior tooth veneer N.I.1.2, N.IV.1.2 may be used for designing at least one device or a plurality of devices of a series 100 of devices for incrementally changing the tooth position of the person P, wherein the at least one device or the plurality of devices may be different from a last device of the series 100.

The design examples are not to scale and are not restrictive. Variations within the scope of skill in the art are possible. Although the invention has been illustrated and described in detail by the preferred embodiment, the invention is not limited by the disclosed examples and other variations may be derived by the skilled person without departing from the scope of protection of the invention.

The further embodiments and embodiments mentioned in the introduction may be combined with one another. The embodiments mentioned in the description of the figures may also be combined with one another. Furthermore, the further embodiments and embodiments mentioned in the introduction may be combined with the embodiments mentioned in the description of the figures.

1. A series (100) of devices for incrementally changing the tooth position of a person (P), comprising at least two devices (10),
wherein the devices (10) each comprise at least one jaw device (11, 12),
wherein the jaw device (11, 12) comprises device elements,
wherein the device elements each comprise at least one receiving region for toothed elements,
wherein the at least one jaw device (11, 12) is configured such that the receiving regions of the jaw device (11, 12) may be placed onto a dental arch of the upper jaw (OK, 5) or the lower jaw (UK, 4) of the person (P),
wherein the devices (10) are designed to provide, when worn according to a predetermined sequence of the devices (10), an incrementally progressive change in tooth position by mechanical interaction of the device and at least one tooth element in the dental arch,
characterized in that the at least one jaw device (11, 12) of a first device (10.1, 10.2) carries a first veneering element (N.I.1.2, N.IV.1.2) on its outer side as a partial region of the first device (10.1, 10.2), in that the at least one jaw device (11, 12) of a second device (10.n) carries a second veneering element (N.I.1.n, N.IV.1.n) on its outer side as a partial region of the second device (10),
in that the at least one jaw device (11, 12) of a third device (10.n) carries a third veneering element (N.I.1.n, N.IV.1.n) on its outer side as a partial region of the third device (10),
that all three veneering elements (N.I.1.2, N.IV.1.2) are in the same position according to a tooth scheme,
that there is a first outer contour and a first inner contour in a first transverse cross-section on the first veneering element,
that there is a second outer contour and a second inner contour on the second veneering element in a second transverse cross-section corresponding to the first transverse cross-section,
that there is preferably a third outer contour and a third inner contour on the third veneering element in a third transverse cross-section corresponding to the first transverse cross-section, and
that the relative position of the respective inner contour to the respective outer contour changes incrementally progressively from the first veneering element via the second veneering element and preferably towards the third veneering element.

2. The series (100) according to claim 1, wherein the at least one first veneering element (N.I.1.2, N.IV.1.2) and the at least one second veneering element (N.I.1.n, N.IV.1.n) substantially coincide in the position and/or the shape of their front-side outer contour,
wherein preferably the front-side outer contour is adapted to the tooth element lying at this tooth position in its target tooth state or in an intermediate target tooth state, as is intended in a final restoration of the tooth element, or represents an enlargement of the target tooth state or intermediate target tooth state in at least one dimension.

3. The series (100) according to claim 1 or 2, wherein the receiving region comprised in the first veneering element (N.I.1.2, N.IV.1.2) causes alignment functions (210) of teeth and shifting functions (220) related to at least one dental arch of the person (P) to be applied to the teeth of the person (P) in an area concealed from the front, in order to bring the at least one dental arch of the person (P) into a new constellation, while the position of the at least one veneering element (N.I.1.2, N.IV.1.2) remains the same or changes only insignificantly, preferably in the course of the entire series (100) or in a part of the series (100) which comprises at least 20 percent of the devices of the series (100), with a total deviation of less than 0.6 mm or less than 0.4 mm, and
preferably while in the area concealed from the front, the incremental changes are carried out at receiving regions and/or recesses for the teeth in the devices (10).

4. The series (100) according to one of claims 1 to 3, wherein at least a subset of the devices (10) in the molar regions of the upper jaw device (11) and/or of the lower jaw device (12) a combination of superstructures with height function (250) and superstructures with sliding function (260) and/or a combination of superstructures with height function (250) and superstructures with “upper jaw”-“lower jaw” relative positioning function or with ramp function (270) are formed in such a way that they achieve a displacement of the contact plane and the future masticatory plane relative to the initial state of the treatment and, in particular, a cranial and/or facial optimization of the masticatory apparatus, wherein the superstructures have a layer thickness and/or height towards an occlusal surface which is at least 2 mm, at least 3 mm or at least 4 mm.

5. The series (100) according to one of claims 1 to 4, wherein at least a subset of the devices (10) has a coloring on at least a subset of the veneering elements (N.I.1.2, N.IV.1.2) of the devices (10) visible from the front, wherein the coloring is preferably achieved as an effect of the material selection or by a preferably lacquer-like coating of the outer material layer of the devices (10) of the at least one part of the devices (10), and
wherein the coloring comprises a white component and/or a yellow component.

6. The series (100) according to one of claims 1 to 5, wherein at least one device (10) of the series (100), preferably a device (10) of the first 20 percent of the series (100), each have at least one veneering element (N.I.1.2, N.IV.1.2) which completely or largely conceals the teeth and/or tooth stumps of the person (P) in the region visible from the front, in order to carry out displacements on these teeth and/or tooth stumps behind this in the concealed region, which preferably consist of incremental superpositions of translation and rotation, in order to guide the teeth and/or tooth stumps in the concealed region towards the target position, while the concealment conceals these processes as seen from the front.

7. The series (100) according to one of claims 1 to 6, wherein at least one part of the devices (10) is designed such that a height superstructure is first carried out in the molar region of the person (P) by means of a height function (250), wherein the height superstructure is suitable for increasing the distance of the lower jaw (UK, 4) from the upper jaw (OK, 5) in the contact bite and thereby leading to an unblocking of previously blocked tooth displacements, and
wherein at least one further part of the devices (10) is designed such that this deblocking achieved by the height functions (250) is followed by a tooth displacement of teeth of the person (P) by aligner functions (210) as part of the subsequent devices (10.n) and/or a change in the dental arch of the person (P) by shifting functions (220) as an additional part of the subsequent devices (10.n).

8. The series (100) according to one of claims 1 to 7, wherein in at least a subset of the devices (10), in addition to alignment functions (210) and or shifting functions (220), height functions (250) are also combined with sliding functions (260), so that at least a subset of the devices (10) have sliding surfaces on the right and left, which are smooth and/or not keyed at least in some areas, so that in this area they lead to a neuromuscular stabilization requirement of the lower jaw (UK, 4) relative to the upper jaw (OK, 5) when an active contact force is exerted by the wearer of the device (10).

9. The series (100) according to one of claims 1 to 8, wherein in at least one part of the devices (10), in addition to alignment functions (210) relating to individual teeth of the person (P) and/or shifting functions (220) relating to the dental arch of the person (P), ramp functions (270) are also integrated, which are suitable, as a result of the locally viewed inclined plane at at least one ramp, to generate a lateral reaction force under contact force between the lower jaw (UK, 4) and the upper jaw (OK, 5), which moves the lower jaw (UK, 4) relative to the upper jaw (OK, 5) in at least one of the combined transverse directions right-left and/or back-front.

10. The series (100) according to one of claims 1 to 9, wherein the last device (10.x) of the series (100) is configured in such a way that an reproduction of the planned final restoration (300) is achieved or a reproduction as accurately as possible, wherein the reproduction of the final restoration is achieved at least in the visible anterior tooth region by anterior veneering elements or tooth veneers (N.I.1.2, N.IV.1.2), which are preferably shaped in accordance with the planned final restoration (300) and are optionally dentally colored in accordance with the planned final restoration (300) by means of color functions (240),
whereby preferably the anterior veneering elements or tooth veneers (N.I.1.2, N.IV.1.2) are temporary and are preferably replaced in the final restoration (300) by a fixed restoration.

11. The series (100) according to one of claims 1 to 10, wherein the last device (10x) of the series (100) is configured in such a way that a reproduction as accurate as possible of the planned final restoration (300) of the teeth of the person (P) is achieved, wherein the reproduction of the final restoration is carried out at least in the molar region by molar elements, in particular molar veneering elements, which have a chewing surface geometry and an orientation of the chewing surface corresponding to the planned final restoration (300), which is determined on the basis of a cranial geometry and/or anatomy of the skull of the person (P).

12. The series (100) according to any one of claims 1 to 8, wherein in at least a subset of the devices (10) at least one height profile element is present at occlusal surfaces, wherein a height of the height profile element is at least twice as high compared to the height at other occlusal surfaces of the same upper jaw device (11) or the same lower jaw device (12),
wherein the height in the region of the height profile element is preferably greater than 2 mm or greater than 3 mm or greater than 4 mm, and
wherein the height profile element is preferably present in the first device (10) and/or in at least one device (10) of the first 20 percent of the devices of the series (100).

13. The series (100) according to claim 12, wherein in the same upper jaw device (11) or the same lower jaw device (12) there are left and right height profile elements with different heights from each other at the same molar positions,
whereby the height difference is preferably at least 1 mm, at least 2 mm or at least 3 mm.

14. The series (100) according to one of the preceding claims, wherein the first device (10.1, 10.2) comprises a first anterior tooth veneer (N.I.1.2, N.IV.1.2),
wherein the first anterior tooth veneer (N.I.1.2, N.IV.1.2) of the first device (10.1, 10.2) is adjacent to a first recess (A.I.1.2, A.IV.1.2) for an anterior tooth (Z.I.1, Z.IV.1.2) of the person (P),
wherein the second device (10.n) comprises a first anterior tooth veneer (N.I.1.n, N.IV.1.n),
wherein the first anterior tooth veneer (N.I.1.n, N.IV.1.n) of the second device (10.n) is adjacent to a first recess (A.I.1.n, N.IV.1.n) for the same anterior tooth (Z.I.1, Z.IV.1.2) of the person (P),
wherein at least the labial outer surface of the first anterior tooth veneer (N.I.1.2, N.IV.1.2) of the first device (10.1, 10.2) is equal to the labial outer surface of the first anterior diaphragm (N.I.1.n, N.IV.1.n) of the second device (10.n) or is only insignificantly different from this outer surface,
wherein the first recess (A.I.1.2, A.IV.1.2) of the first anterior tooth veneer (N.I.1.2, N.IV.1.2) has a first position with respect to the labial outer surface of the first anterior tooth veneer (N.I.1.2, N.IV.1.2),
wherein the first recess (A.I.1.n, A.IV.1.n) of the second anterior tooth veneer (N.I.1.n, N.IV.1.n) has a second position with respect to the labial outer surface of the second anterior tooth veneer (N.I.1.n, N.IV.1.n),
and wherein the first position differs with respect to the second position due to the translation of a tooth of the person (P) along a front-back axis with respect to the head of the person (P),
wherein the first anterior tooth veneer (N.I.1.2, N.IV.1.2) of the first device (10.1, 10.2) has a first material thickness in the labial direction,
wherein the first anterior tooth veneer (N.I.1.n, N.IV.1.n) of the second device (10.n) has a second material thickness in the labial direction, preferably measured at the same position in the second device relative to the measuring position of the first material thickness in the first device, and
whereby the first material thickness deviates from the second material thickness by at least 20 percent or by at least 50 percent.

15. The series (100) according to one of the preceding claims,
wherein the first device (10.1, 10.2) comprises a first anterior tooth veneer (N.I.1.1, N.IV.1.2) and a second anterior tooth veneer (N.III.1.1) which is adjacent to the first anterior tooth veneer (N.IV.1.1) of the first device (10.1, 10.2),
wherein the second device (10.n) comprises a first anterior tooth veneer (N.I.1.n, N.IV.1.n) and a second anterior tooth veneer (N.III.1.n) which is adjacent to the first anterior tooth veneer (N.IV.1.n) of the second device (10.n),
wherein the first anterior tooth veneer (N.IV.1.1) of the first device (10.1) comprises a first recess (A.IV.1.1) for a first anterior tooth (Z.IV.1.1) of the person (P),
wherein the second anterior tooth veneer (N.III.1.n) of the first device (10.1) comprises a second recess (A.III.1.1) for a second anterior tooth (Z.III.1.1) of the person (P),
where the second anterior tooth is next to the first anterior tooth,
wherein the first anterior tooth veneer (N.IV.1.n) of the second device (10.n) comprises a first recess (A.IV.1.n) for the first anterior tooth (Z.IV.1.n) of the person (P),
wherein the second anterior tooth veneer (N.III.1.n) of the second device (10.n) comprises a second recess (A.III.1.n) for the second anterior tooth (Z.III.1.n) of the person (P),
wherein the two anterior tooth veneers (N.IV.1.1, N.III.1.1) of the first device (10.1) are equal at least at occlusal surfaces and/or at labial surfaces to the two anterior tooth veneers (N.IV.1.n, N.III.1.n) of the second devices (10.1), preferably with respect to the maximum width of an occlusal surface and/or the maximum width of a labial surface and/or the distance of the mutually adjacent occlusal surfaces from one another and/or the distance of the mutually adjacent labial surfaces from one another,
wherein the two recesses (A.IV.1.1, A.III.1.1) of the first device (10.1) have a first distance (D11.2a) from one another,
wherein the two recesses (A.IV.1.n, A.III.1.n) of the second device (10.n) have a second distance (D11.2b) from each other,
wherein the size of the first distance (D11.2a) differs by at least 20 percent or at least 50 percent from the size of the second distance (D11.2b), and
wherein the first distance (D11.2a) differs with respect to the second distance (D11.2b) due to a translation of the first anterior tooth of the person (P) along a right-left axis with respect to the head of the person (P) and/or a translation of the second anterior tooth of the person (P) along the right-left axis,
whereby preferably the distance between the two front teeth (Z.IV.1.n, Z.III.1.n) of the person (P) is also increased or reduced.

16. The series (100) according to one of the preceding claims, wherein in at least a subset of the devices (10) or in all devices (10) the veneering elements (N.I.1.2, N.IV.1.2) homogeneously comprise a single material.

17. The series (100) according to one of claims 1 to 16, wherein in at least a subset of the devices (10) or in all devices (10) the veneering elements (N.I.1.2, N.IV.1.2) comprise at least two materials different from each other, preferably a first material in an outer region (19) and a second material in an inner region (18) enclosed by the outer region (19),
wherein the first material has a greater hardness than the second material or wherein the second material has a greater hardness than the first material.

18. The series (100) according to claim 17, wherein the material in the inner region (18) extends over several tooth positions or over the entire tooth arch of a part device of a device (10), wherein the outer region (19) is configured to be used successively for at least two different inner regions (18),
wherein preferably a mechanical interface is defined between the inner region (18) and the outer region (19), which is identical via at least two devices (10),
wherein preferably the inner region (18) may be inserted into and/or removed from the outer region (19), in particular using a form fit and/or a force fit.

19. The series (100) according to one of claims 1 to 18, wherein the labial outer surface of the first tooth veneer (N.I.1.2, N.IV.1.2) has a different position in a sagittal sectional plane than the labial outer surface of the second tooth veneer (N.I.1.n, N.IV.1.n) due to a widening of the dental arch, preferably with respect to proximal free ends of a lower jaw device (12) of the respective pair of devices (10), wherein a difference between the positions is at least 1 mm or at least 1.5 mm.

20. The series (100) according to one of the preceding claims, wherein at least one device (10), at least two devices (10), at least three devices (10) or at least four devices (10) or at least 10 devices lie between the first device (10) and the second device in the order of the devices of the series (10), wherein preferably the difference in material layer thicknesses and/or the difference in distances and/or the difference in position is at least 0.5 mm or at least 1 mm or at least 2 mm.

21. A method for designing polyfunctional dental devices, in particular for designing or for designing and manufacturing a series (100) according to any one of claims 1 to 20, comprising:
Recording a starting tooth arrangement of the teeth of a person (P) in their upper jaw (OK, 5) and/or of the teeth of the person (P) in their lower jaw (UK, 4),
Determining at least one reference structure of the person (P) before, during or after the recording,
Determining a target tooth arrangement of the teeth of the upper jaw (OK, 5) of the person (P) taking into account the reference structure,
Determining a target tooth arrangement of the teeth of the lower jaw (UK, 4) of the person (P) taking into account the reference structure,
Based on the start arrangement and the target tooth arrangement, provision of a data set series consisting of digital data set groups for the teeth of the upper jaw (OK, 5) and/or for the teeth of the lower jaw (UK, 4) that follow one another in sequence.

22. The method according to claim 21, wherein the method is preferably used to treat misalignments or signs of ageing in a person's dentition,
wherein preferably a polyfunctional overall treatment plan (BP) is created which integrates a plurality of functions (210 to 290) into the devices of the series (100),
wherein preferably each of the functions (210 to 290) comprises a partial treatment plan (BPa, BPb) relating to the individual teeth or tooth positions of the dentition, and
wherein the overall treatment plan (BP) or an overall treatment plan (BP) describes which of the polyfunctional functions (210 to 290) are activated when and to what extent, wherein at least three, at least 4, at least 5 or at least 6 function types are selected and integrated from the group:
Alignment function (210), wherein a displacement of at least one tooth is effected by small incremental shifts, small incremental tilts or small rotational increments by at least a subset of the devices or by all devices, wherein the increments are preferably smaller than 0.3 mm or smaller than 0.2 mm,
Shifting function (220), wherein a large-scale shifting of teeth by tilting and translation and optionally inclination correction for displacing or changing the dental arch is effected by at least a subset of the devices or by all devices, wherein the dental arch is displaced by at least 1 mm or by at least 2 mm or is extended by at least 1 mm or by at least 2 mm,
Shape function (230), wherein the shape of at least a subset of the devices or of all of the devices of the series (100) is designed with tooth veneers (N.I.1.2, N.IV.1.2), wherein preferably the tooth veneers (N.I.1.2, N.IV.1.2) cover teeth or tooth stumps,
Color function (240), wherein at least a subset of the devices or all devices in or on at least front visible tooth veneers (N.I.1.2, N.IV.1.2) of the device pairs (10) have an individual color, in particular the color of the teeth of the person (P) or another appealing tooth color, in particular a color which is different from a colorless translucent or colorless translucent material,
Height function (250), wherein a preferably solid superstructure with material over the molars in molar regions of the devices or of a subset of the devices takes place, preferably with a layer thickness of at least 2 mm or at least 3 mm or at least 4 mm,
Sliding function (260), wherein a solid superstructure with a formed sliding surface is used in at least a subset of the devices, preferably with a layer thickness of at least 2 mm or at least 3 mm or at least 4 mm and/or with low friction and/or without retentions (recesses, indentations, profile),
Upper jaw/lower jaw relative positioning function, preferably a ramp function (270), wherein in at least a subset of the devices locally incorporated ramps, slopes, springs or other element are used which cause a transversal reaction force upon contact between the upper jaw (11) and the lower jaw (12).
Implant function (280), which in at least a subset of the devices have a supporting function and/or fastening function and/or positioning function of an upper jaw device (11) or a lower jaw device (12) of a pair of devices (10) on implants of the person (P), preferably the implant being loaded predominantly axially,
A carrier function (290) which, in at least a subset of the devices or in all pairs of devices (10), provides a carrier function for an upper jaw device (11) or a lower jar device (12) of at least one of the devices on soft tissue of the person (P), in particular when teeth are missing at important locations in the dental arch, wherein the orthodontically acting alignment function and the aesthetically acting shape function (230) are applied simultaneously and integrated in the devices in at least one subset of the series (100).

23. The method according to claim 21 or 22, wherein at least a subset of the devices (10.n) or all devices (10n) have force-transmitting functional elements (13) which cause alignment functions (210) and shifting functions (220) to be applied to the teeth in the region covered by the at least one tooth veneer in order to bring the dental arch into a new constellation, while the position of the tooth veneer (N.I.1.2, N.IV.1.2) changes only insignificantly, preferably with total deviations over the entire series (100) or over a partial section of the series (100) comprising at least 20 percent of the devices, of less than 1 mm or less than 0.1 mm,
while preferably the changes between the successive steps of the series (100) are carried out in the area concealed from the front at the receiving regions for the teeth.

24. The method according to any one of claims 21 to 23, wherein at least in a part of the devices in the molar regions of the upper jaw device (11) and/or of the lower jaw device (12) a combination of superstructures with height function (250) and superstructures with sliding function (260) and/or a combination of superstructures with height function (250) and superstructures with “upper jaw”-“lower jaw” relative positioning function or with ramp function (270) are shaped in such a way that they are suitable for achieving a displacement of the contact plane and the future masticatory plane relative to the initial state of the treatment and, in particular, a cranial and/or facial optimization of the masticatory apparatus.

25. The method according to any one of claims 21 to 24, wherein at least a subset of the devices has an aesthetic coloring on a subset of the front visible tooth veneers (N.I.1.2, N.IV.1.2) of the devices, wherein the coloring is preferably achieved as an effect of material selection or by a lacquer-like coating of the outer material layer of the devices of the at least a subset of the devices.

26. The method according to one of claims 21 to 25, wherein at least one of the first 20 percent of the devices of the series (100), preferably at least one device pair (10) of the first 20 percent of the devices of the series (100), each has at least one tooth veneer or tooth veneers (N.I.1.2, N.IV.1.2), which completely or largely cover the teeth and/or tooth stumps of the person (P) in the area visible from the front, in order to carry out displacements on these teeth and/or tooth stumps behind them in the concealed area, which preferably consist of incremental superpositions of translation and rotation and which guide the teeth and/or tooth stumps in the concealed area to the target position, while the covering conceals these processes as seen from the front.

27. The method according to one of claims 21 to 26, wherein a height superstructure is first carried out in the molar region of the person (P) on the devices of the series (100) by means of a height function (250), which is suitable for increasing the distance of the lower jaw (UK, 4) from the upper jaw (OK, 5) of the person (P) in the contact bite and thereby leading to a deblocking of previously blocked tooth displacements,
whereby this deblocking by means of the height functions (250) as part of the device pairs (10.n), is followed by a suitable tooth displacement by means of aligner functions (210) and/or shifting functions (220) as an additional subset of the subsequent device pairs (10.x).

28. The method according to any one of claims 21 to 27, wherein in addition to alignment functions (210) and or shifting functions (220), height functions (250) are also combined with sliding functions (260) in at least one of the devices, so that at least a subset of the devices have sliding surfaces on the right and left, which are smooth and/or not keyed at least in some areas, so that in this area they lead to a neuromuscular stabilization requirement of the lower jaw (UK, 4) relative to the upper jaw (OK, 5) when an active contact force is exerted by the wearer of the pair of devices (10).

29. The method according to any one of claims 21 to 28, wherein in at least one of the devices, in addition to alignment functions (210) and/or shifting functions (220), also an upper jaw/-lower jaw relative positioning function, in particular one or more ramp functions (270), are integrated, which are suitable to generate a lateral reaction force as a result of the locally viewed inclined plane under contact force between the lower jaw (UK, 4) and the upper jaw (OK, 5), which moves the lower jaw (UK, 4) relative to the upper jaw (OK, 5) at least in one of the combined transverse directions right-left and/or rear-front.

30. The method according to one of claims 21 to 29, wherein the last pair of devices (10.x) of the series (100) is designed in such a way that a reproduction as accurate as possible of the planned final restoration (300) is achieved, wherein the reproduction of the final restoration (300) is carried out at least in the visible anterior tooth region by means of tooth veneers (N.I.1.2, N.IV.1.2), which are preferably shaped according to the planned final restoration (300) and optionally dentally colored according to the planned final restoration by means of color functions (240).

31. The method according to one of claims 21 to 30, wherein the last pair of devices (10x) of the series (100) is configured in such a way that the planned final restoration (300) of the teeth of the person (P) is mapped as accurately as possible, wherein the mapping of the final restoration is carried out at least in the molar region by tooth veneers or groups of tooth veneers, which, corresponding to the planned final restoration (300), have an chewing surface geometry and an orientation of the chewing surface which is designed on the basis of the cranial geometry and anatomy of the skull and/or is designed on at least one facial feature of the person (P) with reference to the skull.

32. The method according to claim 31, wherein after wearing the last pair of devices according to a treatment plan (BP2 to BP4), a final restoration (300) of the teeth and/or tooth stumps of the person (P) is carried out,
wherein the final restoration (300) creates a permanent chewing surface that conforms to a planned chewing surface, and/or
wherein the final restoration (300) creates an anterior surface which corresponds to the planned anterior surface, in particular to the shape and/or position of the labial outer surfaces of the at least one tooth veneer (N.I.1.2, N.IV.1.2).

33. A manufacturing method, in particular for manufacturing a series according to any one of claims 1 to 20 or based on the devices of the series (100) designed according to any one of claims 21 to 32, wherein a subtractive manufacturing process is used to manufacture the series (100) from devices or from pairs of devices (10.1 to 10.n) or at least to manufacture a part of the devices,
preferably using a subtractive machining process, in particular milling, or
wherein an additive manufacturing process is used to manufacture the series (100) from devices or from pairs of devices (10.1 to 10.n) or at least to manufacture a part of the devices, in particular 3D printing,
wherein in at least one device or in at least one pair of devices of a device, undercuts and/or differences in material layer thickness of more than 2 mm or more than 4 mm are realized in relation to a height direction in the center of occlusal surfaces of the same device, in particular of the same device part.

34. A computer (1600) comprising:
at least one memory unit (M) adapted to store a program, and
a control unit (P) adapted to execute instructions of the program that cause the computer to execute at least a part of the method according to any one of claims 21 to 33, in particular the steps related to the design of the devices of the series (100), and/or
a computer program comprising machine-readable instructions which, when executed by a control unit (P), cause the control unit (P) to execute at a least part of the method according to any one of claims 21 to 33, and/or
a computer program product comprising machine-readable instructions which, when executed by a control unit (P), cause the control unit (P) to execute at least part of the method according to any one of claims 21 to 33, and/or
digital data generated by a method according to any one of claims 21 to 32 or required by a method according to claim 33, in particular design data and/or manufacturing data for manufacturing the devices of the series (100) or device pairs (10) of the devices of the series (100) with a manufacturing machine (Ma).
